(19) United States
(12) Patent Application Publication
(10) Pub. No.: US 2015/0137522 A1
(43) Pub. Date: May 21, 2015

(54) WATER FLOW GENERATOR

(71) Applicant: Hiroshi Kagayama, Tokyo (JP)

(72) Inventor: Hiroshi Kagayama, Tokyo (JP)

(21) Appl. No.: 14/009,719

(22) PCT Filed: Dec. 13, 2012
(86) PCT No.: PCT/JP2012/082295

§ 371 Date: Oct. 3, 2013

(30) Foreign Application Priority Data
Jul. 19, 2012 (JP) 2012-160660

(51) Int. Cl. F03B 13/10

(52) U.S. Cl. CPC F03B 13/10
USPC 290/54

(57) ABSTRACT

To efficiently convert energy of the flowing water which flows through a marine area to electric power, a water flow generator integrally includes a power generation tower, a twin float, belts, a center piston, side pistons, and a crank ship. Water flow resistance of stop plates in the center piston and the side pistons becomes larger when the respective pistons move forward, and becomes smaller when the respective pistons move backward.

### TECHNICAL FIELD

The present invention relates to a water flow generator which generates electric power from flowing water.

### BACKGROUND

As literatures that disclose this kind of water flow generator, there are Japanese Patent Laid Open No. 2006-46152, Japanese Patent Laid Open No. 2004-270674 and Japanese Utility Model Registration No. 3126740. The water flow generator disclosed in Japanese Patent Laid Open No. 2006-46152 particularly uses an existing water channel for a water wheel to rotate a circular body stretched between two drums so as to generate electric power from its mechanical power. The water flow generator disclosed in Japanese Patent Laid Open No. 2004-270674 includes a floating body moored to resist the flow of flowing water, and a plurality of pressure bearing bodies that are attached to the floating body and move along the flow. Then, the water flow generator has a simple structure and can be reduced in size and weight, and also can be easily installed without civil engineering works. In the water flow generator disclosed in Japanese Utility Model Registration No. 3126740 a belt having a lot of water-receiving pockets in its moving direction is arranged over a plurality of rotating bodies, and the mechanical power of a driving roller rotated by the frictional force of the belt travelling by hydraulic power is transmitted to a power generator to extract electric power.

### SUMMARY OF INVENTION

In a marine area having marine current of about 3 knots at all times like Tsugaru Strait, kinetic energy which can drag a large tanker at 100 meters per minute or more is obtained. In the current situation where problems may occur such as global worming and trouble of nuclear power plant equipment by an earth quake, there is a need for a technology utilizing such kinetic energy from action of marine current to generate electric power.

The present invention is made in view of the above background, and an object thereof is to directly utilize kinetic energy existing within a significant distance in a flowing water direction to efficiently convert it to electric energy, instead of extracting energy only at a point where equipment is installed such as in the conventional technique using a propeller or a turbine.

To solve the above described problem, the present invention provides a water flow generator comprising: a power generator; one or more floating bodies that extend in a forward and backward direction; one or more pulleys pivotally mounted on one surface of each of the one or more floating bodies; a belt wound around each of the one or more pulleys; and two types of pistons respectively supported by one end and another end of the belts so as to be movable alternately forward and backward in opposite directions with respect to one another, each of the pistons including a plurality of walls that surrounds a flow channel extending in the forward and backward direction, one or more stop plates supported within the flow channel, and a drive mechanism that moves the one or more stop plates so as to decrease water flow resistance of the one or more stop plates in the piston when the piston moves backward, and to increase water flow resistance of the one or more stop plates in the piston when the piston moves forward, wherein the power generator is configured to generate electric power by rotational force of a rotating disk or rotational force of the one or more pulleys which are rotated by forward movement or backward movement of the two types of pistons.

According to the present invention, the two types of pistons are supported so as to be movable alternately forward and backward in opposite directions. In addition, water flow resistance of the stop plate for one of the two types of pistons which moves backward becomes smaller, and water flow resistance of the stop plate for one of the two types of pistons which moves forward becomes larger. Further, the power generator is configured to generate electric power by the rotational force of a rotating disk or the rotational force of the pulley which is rotated by the forward movement or backward movement. Thus, according to the present invention, power generation whose power source is the reciprocating motion of pistons continues as long as flowing water exists. Therefore, according to the present invention, energy of the flowing water which flows through a marine area can be efficiently converted to electric power.

In addition, the present invention provides a water flow generator comprising: a power generation tower which includes a power generator, a rotating disk that rotates about an axis, and a gear mechanism that transmits rotational force of the rotating disk to the power generator; a twin float which includes two floating bodies spaced apart, and one or more pulleys, each of the two floating bodies extends in a forward and backward direction and supports the power generation tower by a forward end of the floating body, the one or more pulleys pivotally mounted on one surface of each of the two floating bodies; a belt wound around each of the one or more pulleys; two types of pistons respectively supported by one end and another end of the belts so as to be movable alternately forward and backward in opposite directions with respect to one another within an inside movement space that is a space between the two floating bodies and outside movement spaces between which and the inside movement space the two floating bodies are sandwiched, each of the pistons including a plurality of walls that surrounds a flow channel extending in the forward and backward direction, one or more stop plates supported within the flow channel, and a drive mechanism that moves the one or more stop plates so as to decrease water flow resistance of the one or more stop plates in the piston when the piston moves backward, and to increase water flow resistance of the one or more stop plates in the piston when the piston moves forward; and a crank ship that connects one of the plurality of pistons to the rotating disk in a position away from the rotation axis of the rotating disk.

According to the present invention, the two types of pistons are supported so as to be movable alternately forward and backward in opposite directions. In addition, water flow resistance of the stop plate for one of the two types of pistons which moves backward becomes smaller, and water flow resistance of the stop plate for one of the two types of pistons which moves forward becomes larger. In addition, a forward driving force of one of the two types of pistons which is connected to the rotating disk through the crank ship is converted to the rotational force of the rotating disk by the crank ship. Therefore, according to the present invention, power generation whose power source is the reciprocating motion of pistons continues as long as flowing water exists. Thus, according to the present invention, energy of the flowing water which flows through a marine area can be efficiently converted to electric power.

### BRIEF DESCRIPTION OF DRAWINGS

FIG. 1 is a top view of a water flow generator of one embodiment of the present invention.

FIG. 2 is a left side view of the water flow generator.

FIG. 3 is a front view of the water flow generator.

FIG. 4 is a rear view of the water flow generator.

FIG. 5 is a top view of a power generation tower of the water flow generator.

FIG. 6 is a bottom view of the power generation tower of the water flow generator.

FIG. 7 is a perspective view of a twin float of the water flow generator.

FIG. 8 is a schematic view of a belt of the water flow generator.

FIG. 9 is a perspective view of a center piston of the water flow generator.

FIG. 10 is a transparent view of FIG. 9.

FIG. 11 is a perspective view of side pistons of the water flow generator.

FIG. 12 is a transparent view of FIG. 11.

FIG. 13 is a diagram illustrating an engagement state of wheels that are protruding portions of the center piston and a rail that is a protruding portion of the twin float in the water flow generator.

FIG. 14 is a diagram illustrating an engagement state of wheels that are protruding portions of the side piston and a rail that is a protruding portion of the twin float in the water flow generator.

FIG. 15 is a perspective view of a crank ship of the water flow generator.

FIG. 16 is a diagram illustrating a state of connection of the crank ship with the power generation tower and the center piston in the water flow generator.

FIG. 17 is an enlarged view of stop plates and a drive mechanism in the side piston.

FIG. 18 is a diagram illustrating a state where the drive mechanism is removed from FIG. 17.

FIG. 19 is a transparent view of FIG. 17.

FIG. 20 is a diagram of FIG. 17 viewed from arrow A direction.

FIG. 21 is a diagram of FIG. 17 viewed from arrow B direction.

FIG. 22 is a perspective view of a guide portion in the drive mechanism of FIG. 17.

FIG. 23 is a schematic view of a rail portion in the drive mechanism of FIG. 17.

FIG. 24 is a perspective view of a slide portion in the drive mechanism of FIG. 17.

FIG. 25 is a diagram of FIG. 24 viewed from arrow C direction.

FIG. 26 is a perspective view of a slide portion in the drive mechanism of FIG. 17.

FIG. 27 is a left side view of FIG. 26.

FIG. 28 is a bottom view of FIG. 26.

FIG. 29 is a diagram illustrating an operation of the drive mechanism of the water flow generator.

FIG. 30 is a diagram illustrating an operation of the drive mechanism of the water flow generator.

FIG. 31 is a diagram illustrating one example of mooring equipment of the water flow generator.

### DETAILED DESCRIPTION

An embodiment of the present invention will be described below with reference to the drawings.

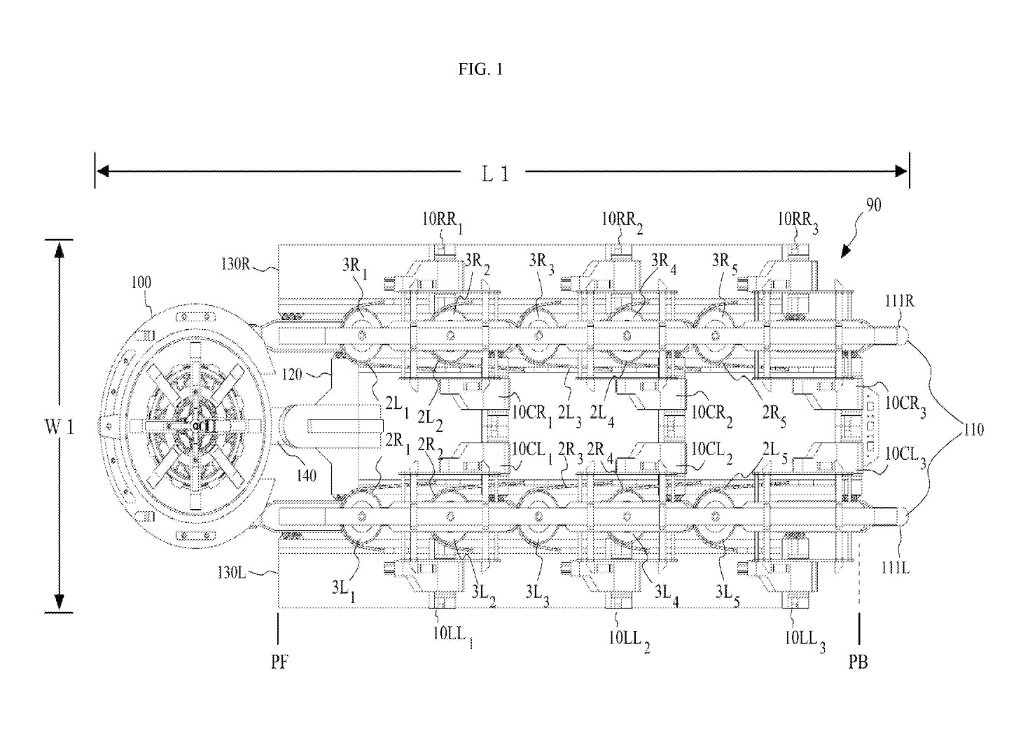

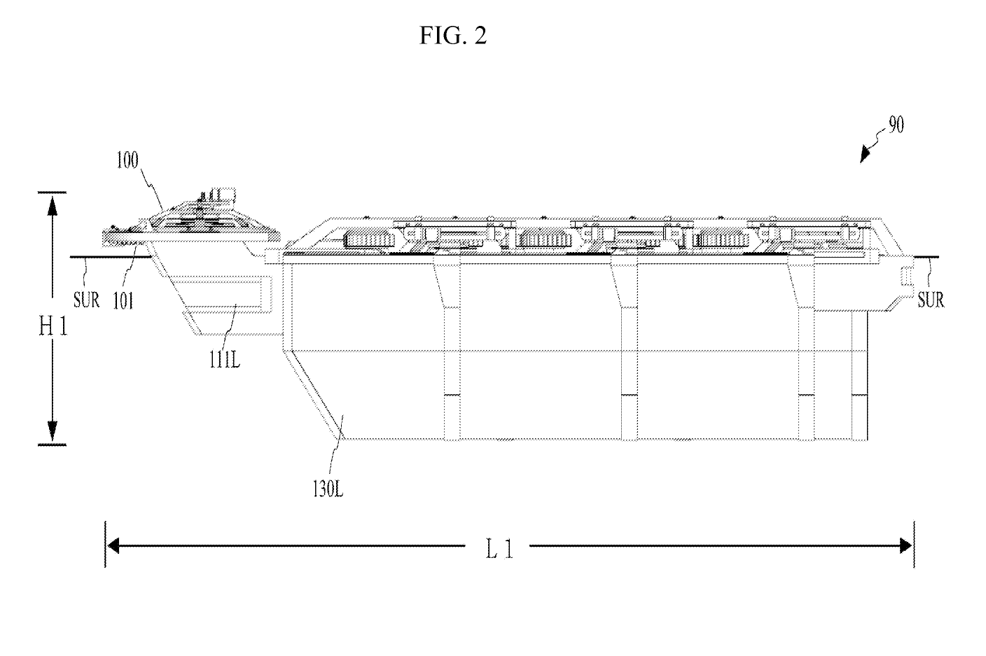

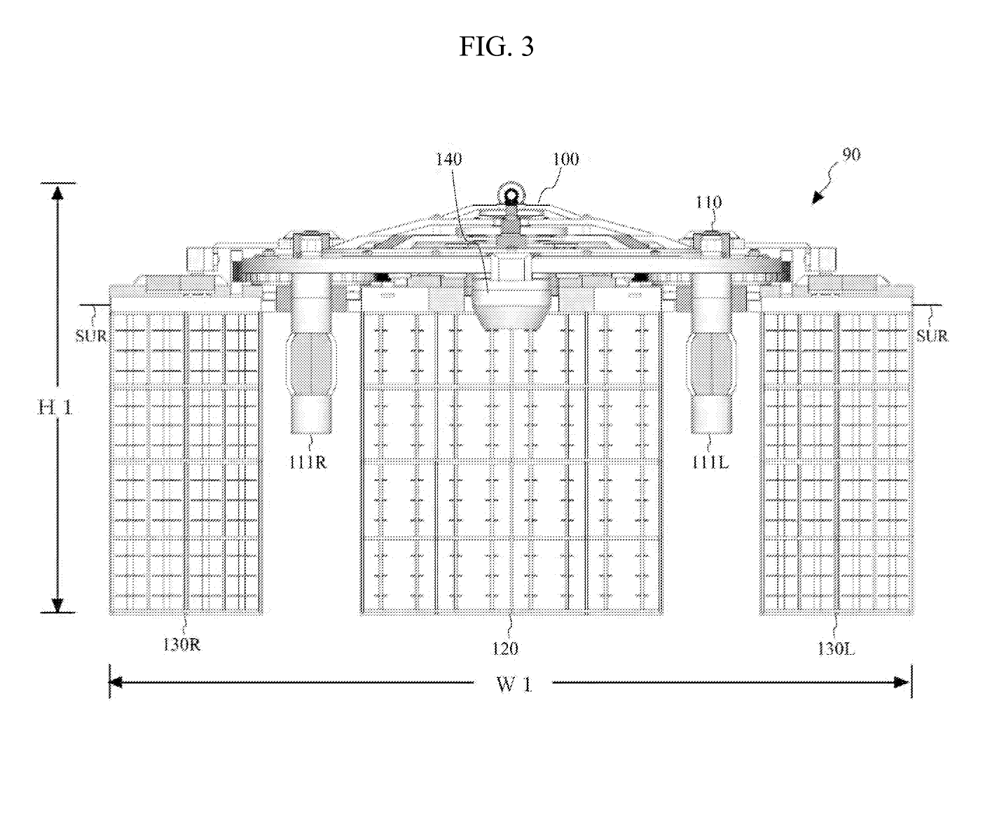

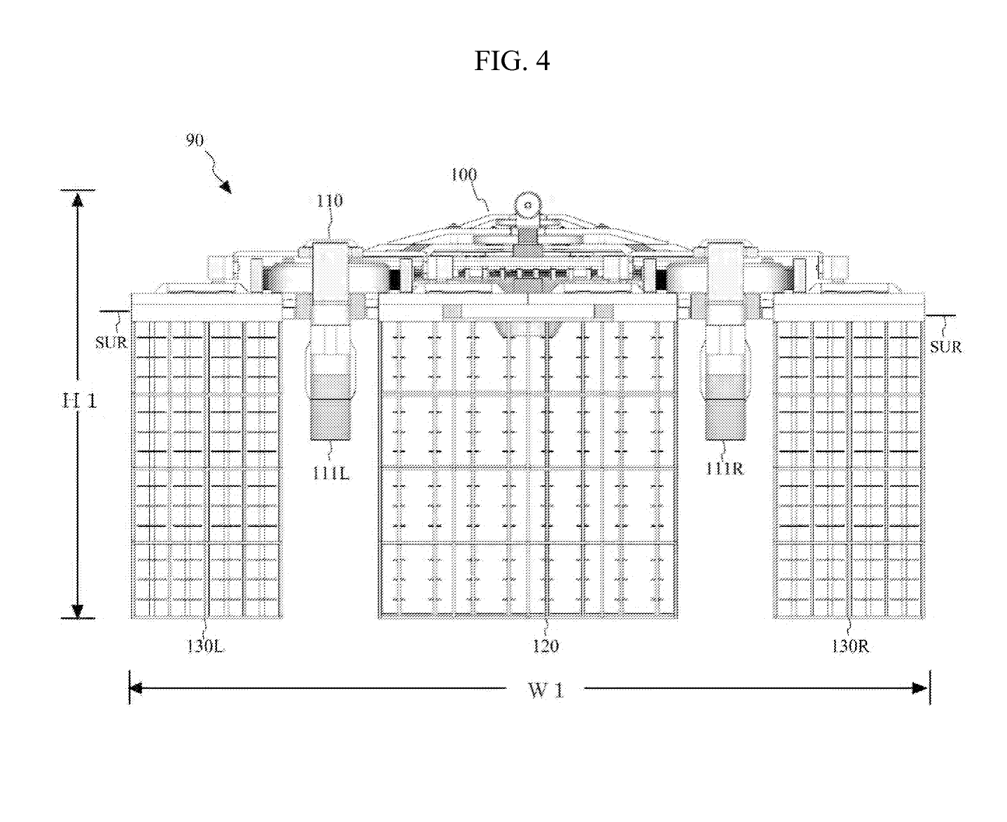

FIG. 1 is a top view of a water flow generator 90 of one embodiment of the present invention. FIG. 2 is a left side view of the water flow generator 90. FIG. 3 is a front view of the water flow generator 90. FIG. 4 is a rear view of the water flow generator 90. This water flow generator 90 is operated while being moored in a position where there is a marine current at an average of 1 to 2 knots or more, ideally around 3 knots on a constant basis, on the sea. The size of the water flow generator 90 may be that of a small boat's body or so to a large cargo vessel or more, and has scalability for output. A large embodiment is supposed here which is sized to have a length of L1 (e.g., L1=450 m), a height of H1 (e.g., H1=85 m), and a width of W1 (e.g., W1=160 m). The water flow generator 90 includes a power generation tower 100, a twin float 110, belts 2Lⱼ (j=1 to 5), 2Rⱼ (j=1 to 5), a center piston 120, side pistons 130L, 130R, and a crank ship 140. In the present embodiment, a direction toward the power generation tower 100 in length L1 direction is defined as forward direction, and a direction opposite to the forward direction is defined as backward direction. In addition, a direction toward the side piston 130L in width W1 direction is defined as left direction, and a direction toward the side piston 130R is defined as right direction. Hereinafter, configurations of the power generation tower 100, the twin float 110, the belts 2Lⱼ (j=1 to 5), 2Rⱼ (j=1 to 5), the center piston 120, the side pistons 130L, 130R, and the crank ship 140 will be described in order.

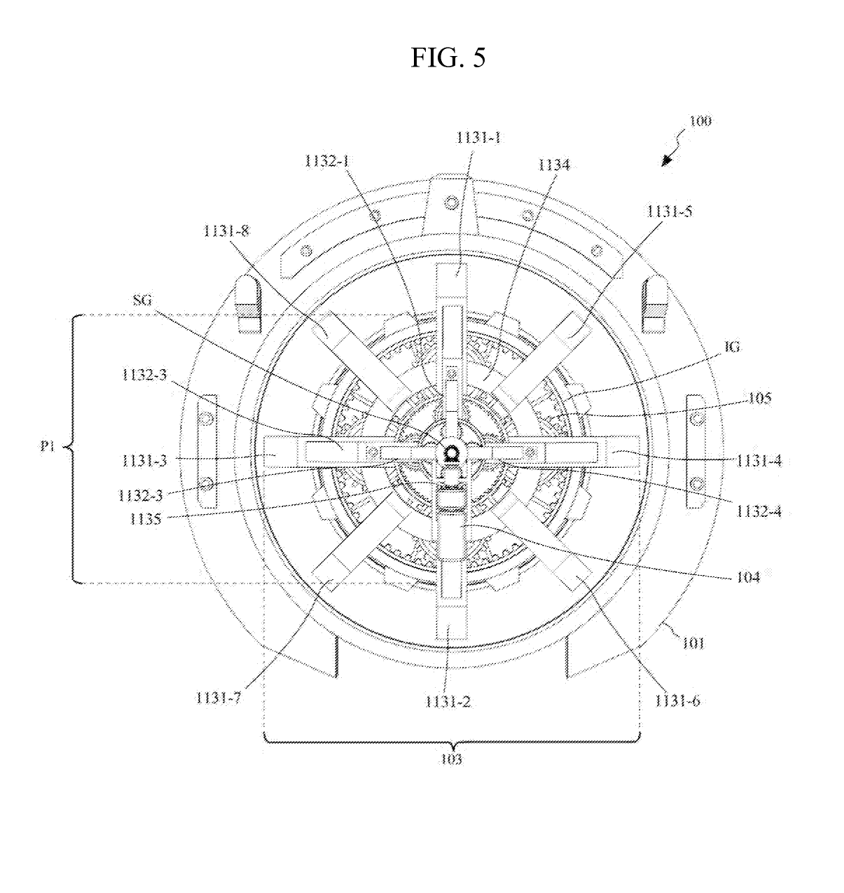

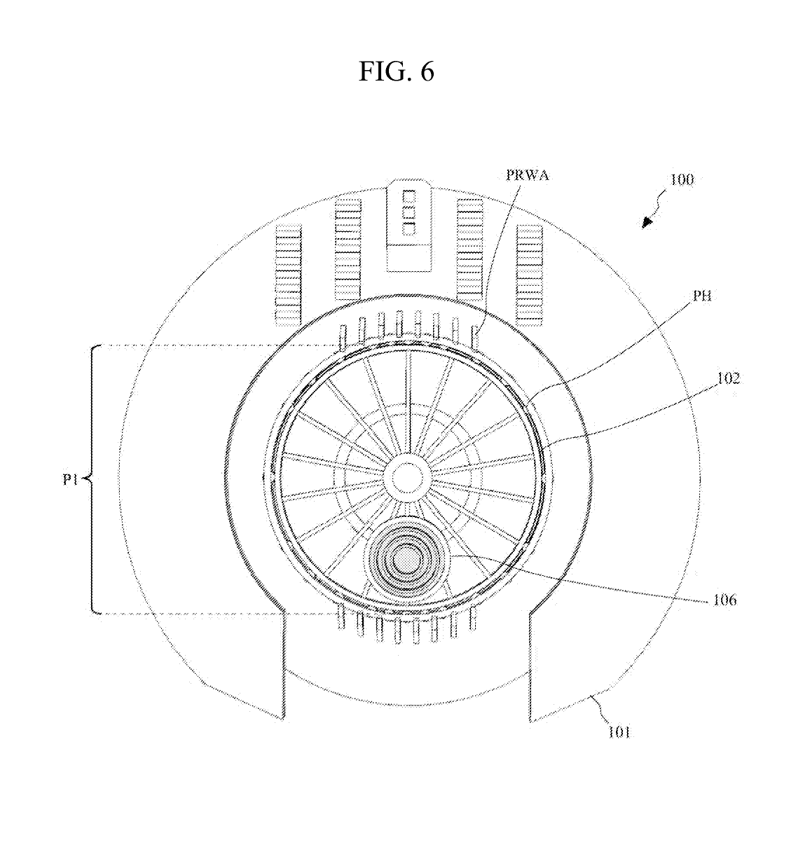

FIG. 5 is a top view of the power generation tower 100. FIG. 6 is a bottom view of the power generation tower 100. The power generation tower 100 includes a support 101, a rotating disk 102, a mounting table 103, a power generator 104, and a gear mechanism 105. The support 101 has a shape like a perfect circle from which a part of its perimeter is cut out inwardly. At the bottom of the center of the support 101, a hole shaped like a perfect circle P1 is formed which penetrates between the upper and lower surfaces of the support. On the inner wall of the hole P1, a rail is provided in a manner to make a circle along the inner perimeter of the hole P1. The rotating disk 102 is fitted in the hole P1. A plurality of wheels (34 wheels in the example of FIGS. 5 and 6) PH intervene between the rail of the hole P1 and the rotating disk 102. Thereby, the rotating disk 102 can rotate along the rail of the hole P1. In addition, there is a connecting portion 106 in a position deviated outward on the lower surface of the rotating disk 102. This connecting portion 106 has four cylindrical walls with different diameters arranged in a concentric pattern.

As shown in FIG. 6, protective walls PRWA are provided in each of portions opposite in forward and backward direction with respect to the hole P1 on the lower surface of the support 101. As shown in FIG. 5, the mounting table 103 is provided on the upper surface of the support 101. This mounting table 103 includes dogleg-shaped flexural members 1131-1 to 1131-4 which extend toward the center of the hole P1 from respective positions opposite in up, down, right and left directions with respect to the center of the hole P1 on the upper surface of the support 101, dogleg-shaped flexural members 1131-5 to 1131-8 which extend toward the center of the hole P1 from respective positions that are rotated by 45 degrees from respective base positions of the four members 1131-1 to 1131-4 about the center of the hole P1 as the rotation axis, an annular member 1134 supported by tip portions of the dogleg-shaped flexural members 1131-1 to 1131-8, dogleg-shaped flexural members 1132-1, 1132-3, 1132-4 which extend toward the center of the hole P1 from tips of the dogleg-shaped flexural members 1131-1, 1131-3, 1131-4, and a power generator holding portion 1135 which is fixed to the tip end of the dogleg-shaped flexural member 1131-2. The power generator 104 is fixed to the power generator holding portion 1135.

Further, the gear mechanism 105 is provided between the rotating disk 102 and the mounting table 103 on the upper surface of the support 101. This gear mechanism 105 is a combination of three layers of a planetary gear mechanism, each layer including one sun gear, four planetary gears, one planetary carrier, and one internal gear. The internal gear IG of the planetary gear mechanism in the first layer (bottom layer) of the gear mechanism 105 is fixed to the upper surface of the rotating disk 102. The sun gear SG of the planetary gear mechanism in the third layer (top layer) of the gear mechanism 105 engages with a driving shaft of the power generator 104. The rotational force of the rotating disk 102 is amplified by the gear mechanism 105, for example, from one revolution per several minutes to several dozen revolutions per minute, and is further transmitted through a common speed increaser used for a large wind generator or the like to the driving shaft of the power generator 104.

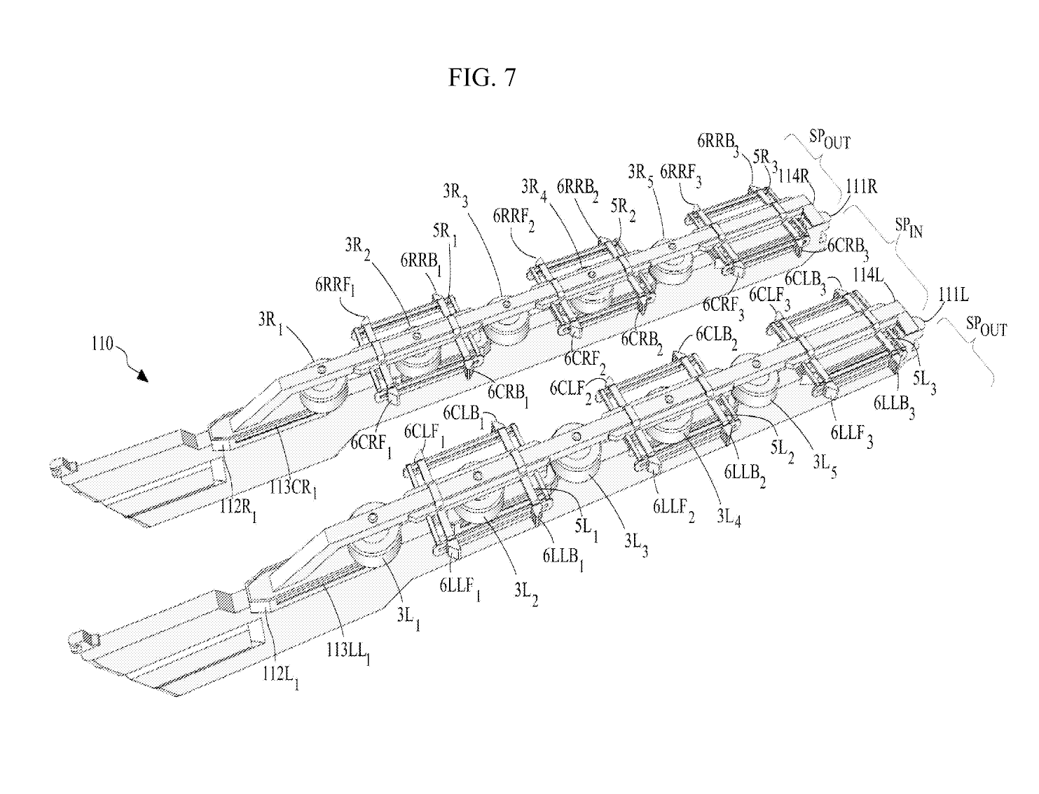

FIG. 7 is a perspective view of the twin float 110. The twin float 110 has two floating bodies 111L and 111R. The floating bodies 111L and 111R are steel members extending in the forward and backward direction. The interiors of the floating bodies 111L and 111R are hollow. As shown in FIG. 2, front parts of the floating bodies 111L and 111R support the support 101 of the power generation tower 100. The interiors of the floating bodies 111L and 111R are filled with air, which is gas whose gravity weight is enough smaller than that of sea water, and ballast water for buoyancy control, so that the twin float 110 can float while supporting the power generation tower 100. Lines SUR in FIGS. 2, 3, 4 indicate the level of water surface in a case where the water flow generator 90 is moored on the sea.

As shown in FIG. 7, pedestal portions 112Lₚ (p=1 to 4) are formed on the upper surface of the floating body 111L. Pedestal portions 112Rₚ (p=1 to 4) are formed on the upper surface of the floating body 111R. For convenience, in FIG. 7, it is omitted to show reference characters 112L₂, 112L₃, 112L₄, 112R₂, 112R₃, 112R₄ of the pedestal portions. On two sides opposite in width W1 direction, of each pedestal portion 112Lₚ (p=1 to 4), rails 113LLₚ and 113CLₚ which extend in length L1 direction are provided. On two sides opposite in width W1 direction, of each pedestal portion 112CRₚ (p=1 to 4), rails 113RRₚ and 113CRₚ which extend in length L1 direction are provided.

On the upper surface of the floating body 111L, an arch portion 114L is provided which extends in the forward and backward direction between a position posterior to the forward end of the floating body and a position of the back end as base ends. On the upper surface of the floating body 111R, an arch portion 114R is provided which extends in the forward and backward direction between a position posterior to the forward end of the floating body and a position of the back end as base ends. Pulleys 3Lⱼ (j=1 to 5) are pivotally mounted between the upper surface of the floating body 111L and the lower surface of the arch portion 114L. Pulleys 3Rⱼ (j=1 to 5) are pivotally mounted between the upper surface of the floating body 111R and the lower surface of the arch portion 114R.

The arch portion 114L is provided with frameworks 5Lᵢ (i=1 to 3). The arch portion 114R is provided with frameworks 5Rᵢ (i=1 to 3). The framework 5Lᵢ (i=1 to 3) has the shape of an approximately quadrangle with four sides formed of one pair of plates extending in width W1 direction with respect to the arch portion 114L and another pair of plates extending between the ends of these plates. The framework 5Rᵢ (i=1 to 3) has the shape of an approximately quadrangle with four sides formed of one pair of plates extending in width W1 direction with respect to the arch portion 114R and another pair of plates extending between the ends of these plates. A long hole extending in length L1 direction is formed in each of the two plates opposite in width W1 direction of the framework 5Lᵢ (i=1 to 3). A long hole extending in length L1 direction is formed in each of the two plates opposite in width W1 direction of the framework 5Rᵢ (i=1 to 3).

On forward end and back ends of a left-side plate of the two plates provided with the long holes of each framework 5Lᵢ (i=1 to 3), there are receiving portions 6LLFᵢ and 6LLBᵢ which protrude to the left side. On forward end and back ends of a right-side plate of the two plates provided with the long holes of each framework 5Lᵢ (i=1 to 3), there are receiving portions 6CLFᵢ and 6CLBᵢ which protrude to the right side. On forward end and back ends of a right-side plate of the two plates provided with the long holes of each framework 5Rᵢ (i=1 to 3), there are receiving portions 6RRFᵢ and 6RRBᵢ which protrude to the right side. On forward and back ends of a left-side plate of the two plates provided with the long holes of each framework 5Rᵢ (i=1 to 3), there are receiving portions 6CRFᵢ and 6CRBᵢ which protrude to the left side.

The receiving portions 6LLFᵢ (i=1 to 3), 6LLBᵢ (i=1 to 3), 6CLFᵢ (i=1 to 3), 6CLBᵢ (i=1 to 3), 6RRFᵢ (i=1 to 3), 6RRBᵢ (i=1 to 3), 6CRFᵢ (i=1 to 3), 6CRBᵢ (i=1 to 3) have the shape of a triangle pole. The receiving portion 6LLFᵢ and the receiving portion 6LLBᵢ face to each other in parallel at an interval in the forward and backward direction. The receiving portion 6CLFᵢ and the receiving portion 6CLBᵢ face to each other in parallel at an interval in the forward and backward direction. The receiving portion 6RRFᵢ and the receiving portion 6RRBᵢ face to each other in parallel at an interval in the forward and backward direction. The receiving portion 6CRFᵢ and the receiving portion 6CRBᵢ face to each other in parallel at an interval in the forward and backward direction.

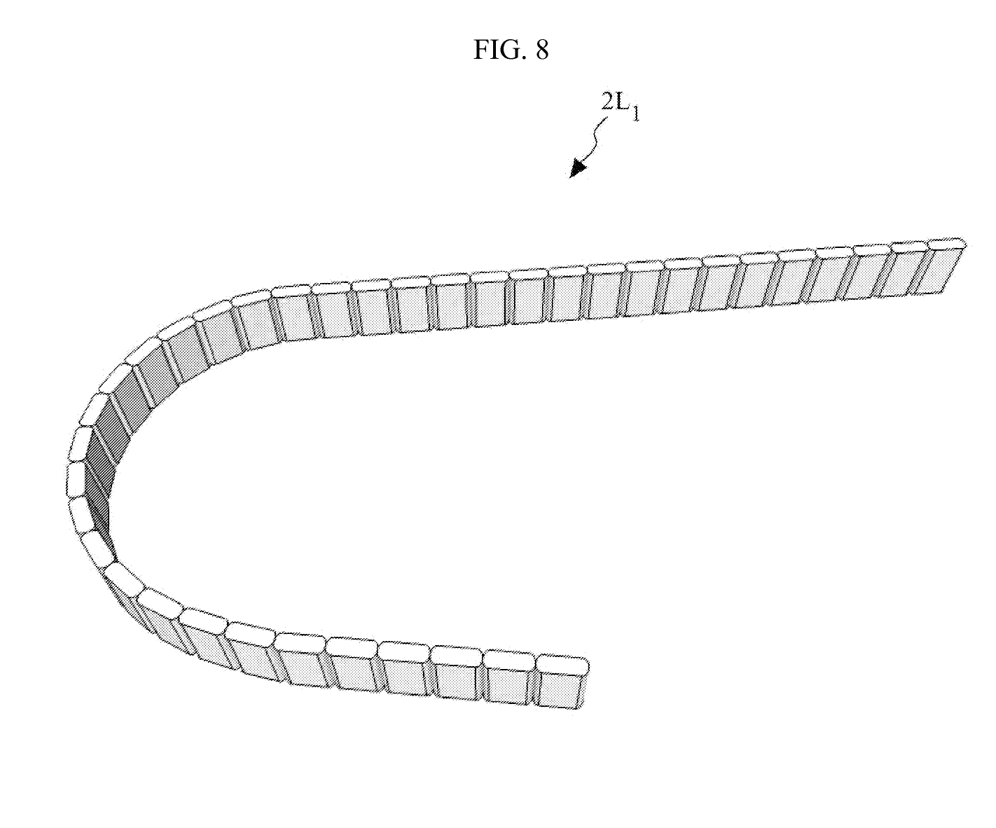

FIG. 8 is a schematic diagram of a belt 2L₁. The belt 2L₁ is steel blocks connected in series such that connecting portions of the steel blocks are each turnable with respect to their corresponding connecting portions. Configurations of belts 2L₂, 2L₃, 2L₄, 2L₅, 2Rⱼ (j=1 to 5) are the same as the configuration of the belt 2L₁. As shown in FIG. 1, the belts 2Lⱼ (j=1 to 5) and 2Rⱼ (j=1 to 5) are wounded around the pulleys 3Lⱼ (j=1 to 5) and 3R₄ (j=1 to 5) of the respective floating bodies 111L and 111R of the twin float 110.

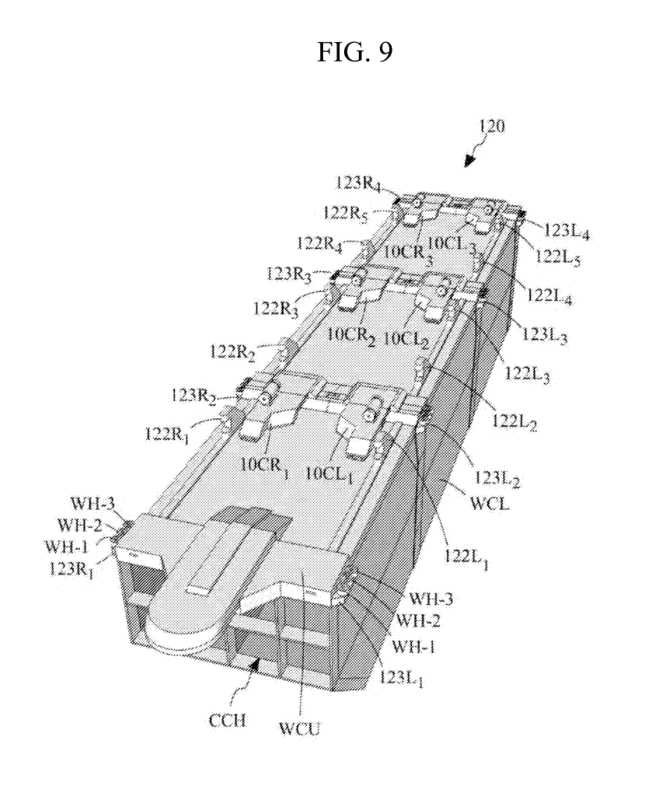

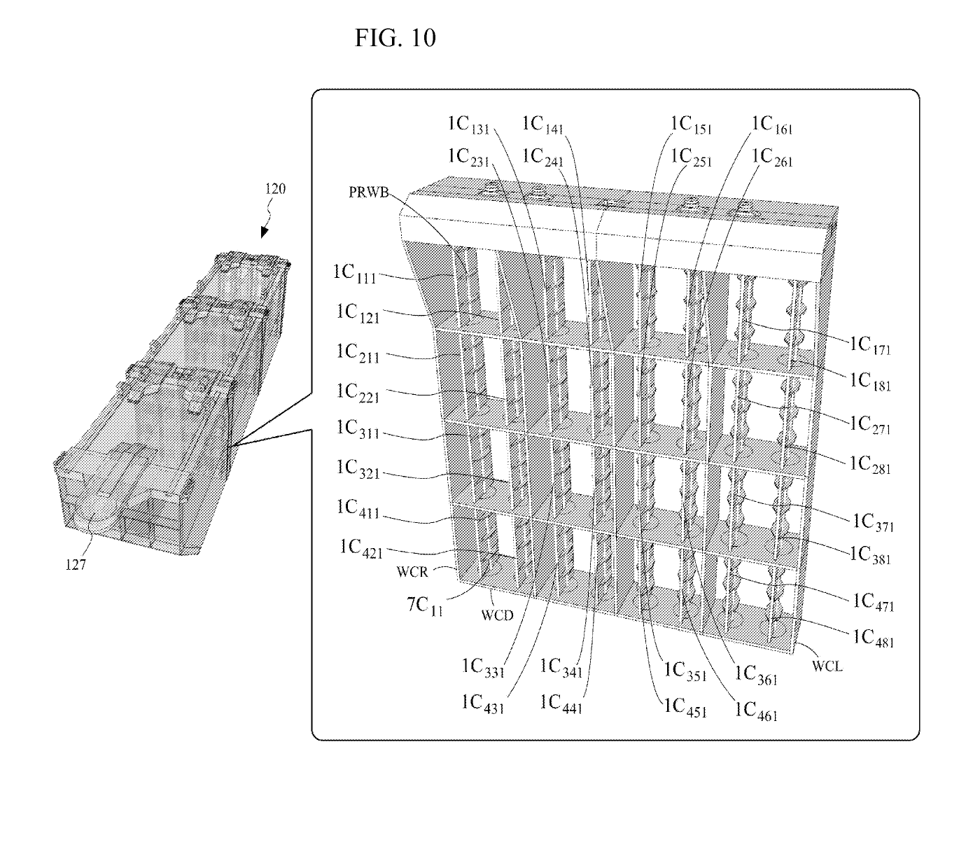

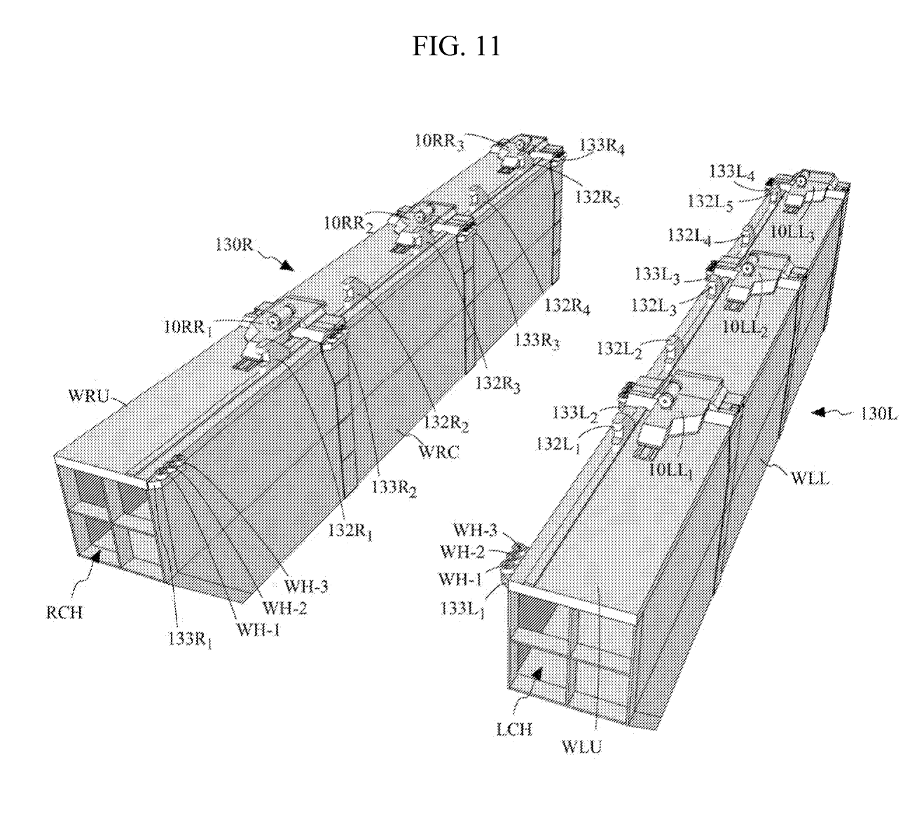

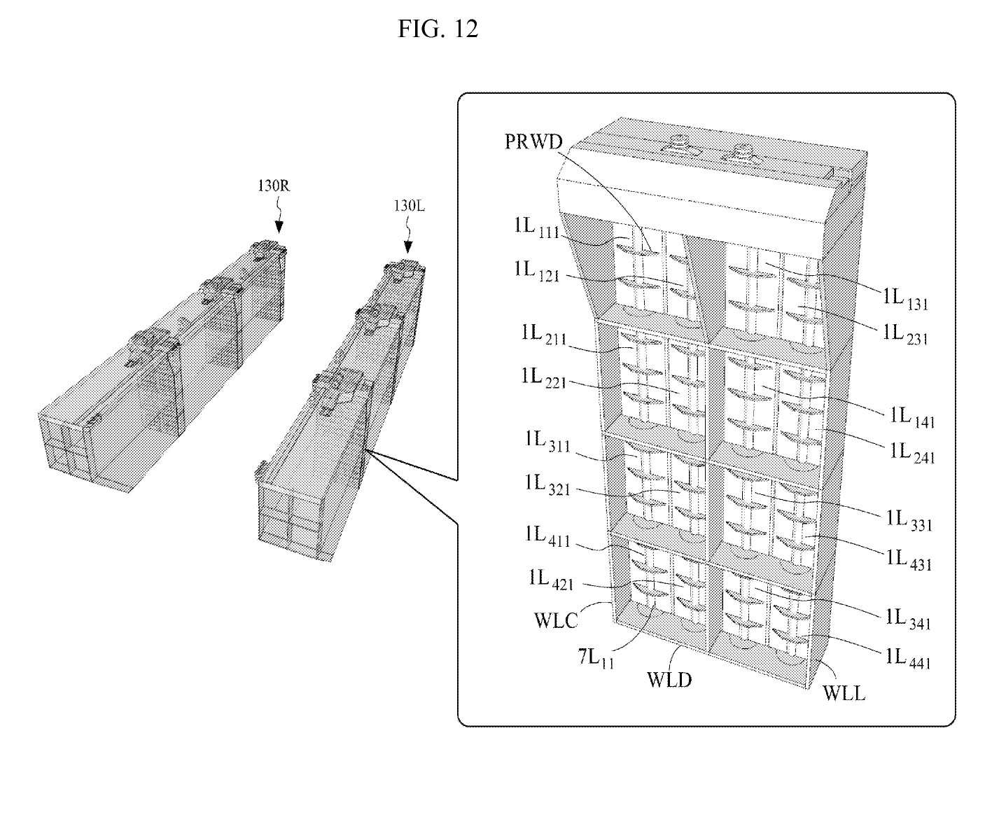

FIG. 9 is a perspective view of the center piston 120. FIG. 10 is a transparent view of FIG. 9. FIG. 11 is a perspective view of the side pistons 130L, 130R. FIG. 12 is a transparent view of FIG. 11. The center piston 120 and the side pistons 130L, 130R are supported by one ends and another ends of the belts 2Lⱼ (j=1 to 5) and 2Rⱼ (j=1 to 5) so as to be movable alternately forward and backward in opposite directions, within a space between the floating bodies 111L and 111R (hereinafter referred to as an inside movement space SP_{IN}, see FIG. 7) and spaces between which the floating bodies 111L and 111R are sandwiched and that are opposite with respect to the inside movement space SP_{IN} (hereinafter referred to as outside movement spaces SP_{OUT}, see FIG. 7). Two types of pistons will be described in detail. As shown in FIG. 9 and FIG. 10, the center piston 120 has four walls WCU, WCD, WCL, WCR that surround a channel CCH from up, down, left and right directions, the channel CCH extending in the forward and backward direction. The interior of the wall WCU is filled with air, so the center piston 120 can float. A middle part of the forward end of the wall WCU protrudes forward, and on the lower surface of this protruding portion, a connecting portion 127 is provided. The connecting portion 127 has four cylindrical walls with different diameters arranged in a concentric pattern.

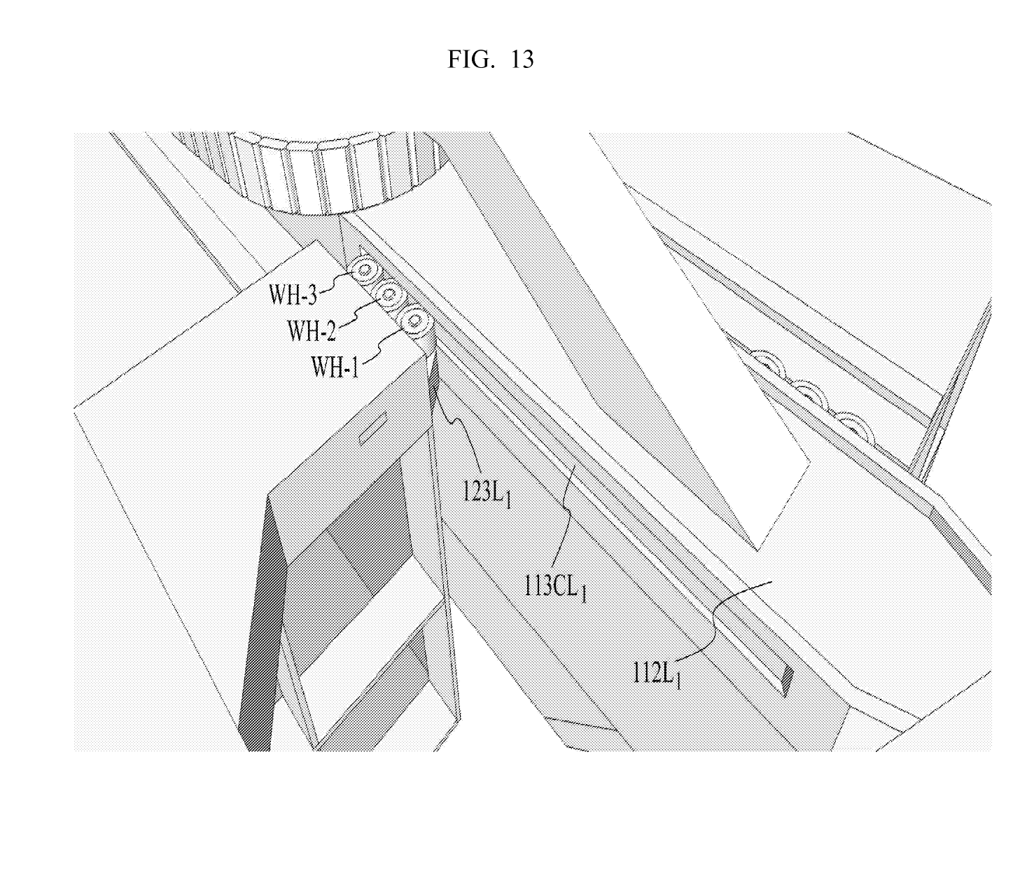

Inside edges opposite in width W1 direction on the upper surface of the wall WCU, protruding portions 122Lⱼ (j=1 to 4), 122Rⱼ (j=1 to 4) which protrude upward are provided. A forward end face of each of the protruding portions 122Lⱼ (j=1 to 4), 122Rⱼ (j=1 to 4) has a belt connecting portion. As shown in FIG. 1, an end (right end) of the belt 2Lⱼ (j=1 to 5) is fixed to the belt connecting portion of the protruding portion 122Lⱼ (j=1 to 4). An end (left end) of the belt 2Rⱼ (j=1 to 5) is fixed to the belt connecting portion of the protruding portion 122Rⱼ (j=1 to 4). Protruding portions 123Lₚ (p=1 to 4) which horizontally protrude are provided near the upper edge of the wall WCL. Protruding portions 123Rₚ (p=1 to 4) which horizontally protrude are provided near the upper edge of the wall WCR. Three wheels WH-1, WH-2, and WH-3 are pivotally mounted on the upper surface of the protruding portion 123Lₚ (p=1 to 4). Three wheels WH-1, WH-2, and WH-3 are pivotally mounted also on the upper surface of the protruding portion 123Rₚ (p=1 to 4). For convenience, in FIG. 9, it is omitted to show reference characters WH-1, WH-2, and WH-3 of the wheels of the protruding portions 123L₂, 123L₃, 123L₄, 123R₂, 123R₃, 123R₄. As shown in FIG. 13, the wheels WH-1, WH-2, and WH-3 of each protruding portion 123Lₚ (p=1 to 4) are received within the rail 113CLₚ of the floating body 111L so as to slide within the rail 113CLₚ. Similarly, the wheels WH-1, WH-2, and WH-3 of each protruding portion 123Rₚ (p=1 to 4) are received within the rail 113CRₚ of the floating body 111R so as to slide within the rail 113CRₚ.

As shown in FIG. 10, in a position backward away from an inlet of the flow channel CCH within the flow channel CCH of the center piston 120, 32 stop plates 1Cₘₙ₁ (m=1 to 4) (n=1 to 8) are arranged in a matrix with 4 rows and 8 columns. In a position backward away from the stop plates 1Cₘₙ₁ (m=1 to 4) (n=1 to 8) within the flow channel CCH, 32 stop plates 1Cₘₙ₂ (m=1 to 4) (n=1 to 8) are arranged in a matrix with 4 rows and 8 columns. In a position backward away from the stop plates 1Cₘₙ₂ (m=1 to 4) (n=1 to 8) within the flow channel CCH, 32 stop plates 1Cₘₙ₃ (m=1 to 4) (n=1 to 8) are arranged in a matrix with 4 rows and 8 columns. To each stop plate 1Cₘₙᵢ (m=1 to 4) (n=1 to 8) (i=1 to 3), three reinforcing plates PRWB orthogonal thereto are fixed. Four stop plates 1Cₘₙᵢ (m=1 to 4) forming each of n columns among the stop plates 1Cₘₙᵢ (m=1 to 4) (n=1 to 8) (i=1 to 3) are supported by a support bar 7Cₙᵢ which extends through the center of the stop plates 1Cₘₙᵢ (m=1 to 4) and the reinforcing plates PRWB in height H1 direction. The lower end of the support bar 7Cₙᵢ is fitted in a hole of the wall WCD. The upper end of the support bar 7Cₙᵢ is fitted in a hole of the wall WCU. The stop plate 1Cₘₙᵢ and reinforcing plates PRWB can rotate clockwise and counterclockwise about the support bar 7Cₙᵢ.

As shown in FIG. 11 and FIG. 12, the side piston 130L has four walls WLU, WLD, WLL, WLR that surround a flow channel LCH extending in the forward and backward direction. The interior of the wall WLU is filled with air, so the side piston 130L can float. The side piston 130R has four walls WRU, WRD, WRL, WRR that surround a flow channel RCH extending in the forward and backward direction. The interior of the wall WRU is filled with air, so the side piston 130R can float. Inside edges opposite in width W1 direction on the upper surface of the wall WLU, protruding portions 132Lⱼ (j=1 to 5) which protrude upward are provided. Forward end faces of the protruding portions 132Lⱼ (j=1 to 5) have a belt connecting portion. Inside edges opposite in width W1 direction on the upper surface of the wall WRU, protruding portions 132Rⱼ (j=1 to 5) which protrude upward are provided. Forward end faces of the protruding portions 132Rⱼ (j=1 to 5) have a belt connecting portion.

As shown in FIG. 11, an end of the belt 2Lⱼ which is opposite to the side connected to the protruding portion 122Lⱼ is fixed to the belt connecting portion of each protruding portion 132Lⱼ (j=1 to 5). An end of the belt 2Rⱼ which is opposite to the side connected to the protruding portion 122Rⱼ is fixed to the belt connecting portion of each protruding portion 132Rⱼ (j=1 to 5). Protruding portions 133Lₚ (p=1 to 4) which horizontally protrude are provided near the upper edge of the side face of the wall WLR. Protruding portions 133Rₚ (p=1 to 4) which horizontally protrude are provided near the upper edge of the side face of the wall WRL. Three wheels WH-1, WH-2, and WH-3 are pivotally mounted on the upper surface of the protruding portion 133Lₚ (p=1 to 4). Three wheels WH-1, WH-2, and WH-3 are pivotally mounted on the upper surface of the protruding portion 133Rₚ (p=1 to 4). For convenience, in FIG. 11, it is omitted to show reference characters for the wheels WH-1, WH-2, and WH-3 of the wheels of the protruding portions 133L₂, 133L₃, 133L₄, 133R₂, 133R₃, 133R₄.

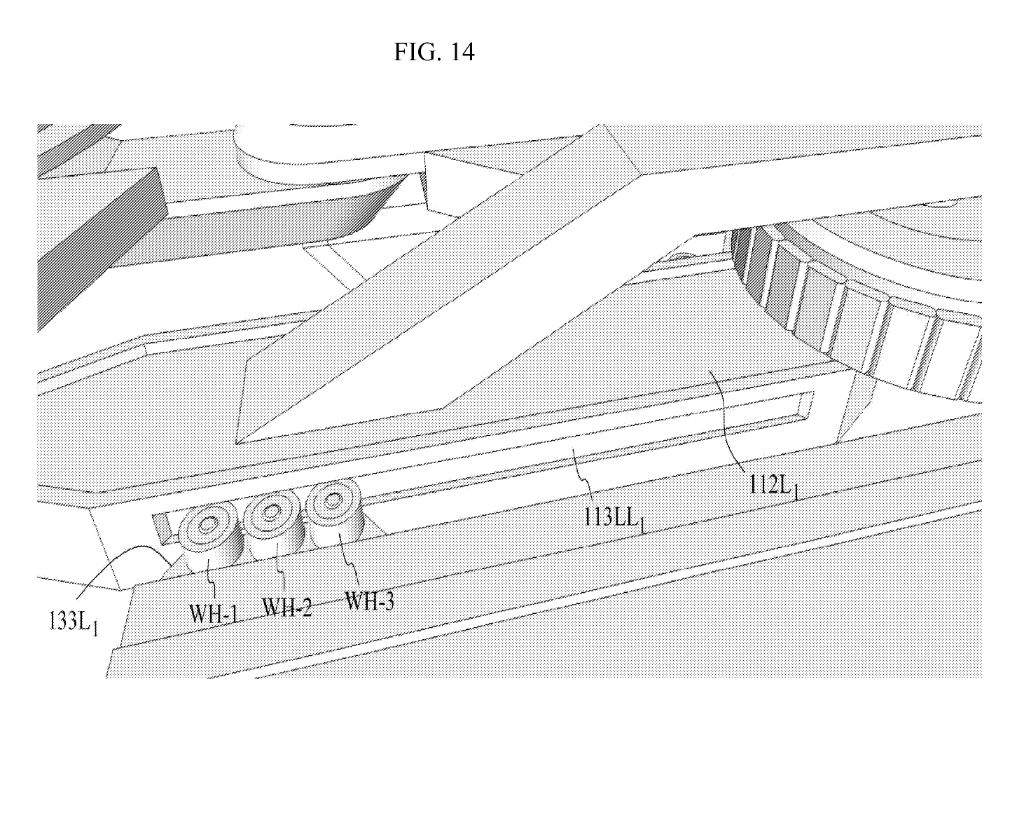

As shown in FIG. 14, the wheels WH-1, WH-2, and WH-3 of each protruding portion 133Lₚ (p=1 to 4) are received within the rail 113LLₚ of the floating body 111L so as to slide within the rail 113LLₚ. Similarly, the wheels WH-1, WH-2, and WH-3 of each protruding portion 133Rₚ (p=1 to 4) are received within the rail 113RRₚ of the floating body 111R so as to slide within the rail 113RRₚ.

As shown in FIG. 12, in a position backward away from an inlet of the flow channel LCH within the flow channel LCH of the side piston 130L, 16 stop plates 1Lₘₖ₁ (m=1 to 4) (k=1 to 4) are arranged in a matrix with 4 rows and 4 columns. In a position backward away from the stop plates 1Lₘₖ₁ (m=1 to 4) (n=1 to 4) within the flow channel LCH, 16 stop plates 1Lₘₖ₂ (m=1 to 4) (k=1 to 4) are arranged in a matrix with 4 rows and 4 columns. In a position backward away from the stop plates 1Lₘₖ₂ (m=1 to 4) (n=1 to 4) within the flow channel LCH, 16 stop plates 1Lₘₖ₃ (m=1 to 4) (k=1 to 4) are arranged in a matrix with 4 rows and 4 columns. To each stop plate 1Lₘₖᵢ (m=1 to 4) (k=1 to 4) (i=1 to 3), three reinforcing plates PRWB orthogonal thereto are fixed. Four stop plates 1Lₘₖᵢ (m=1 to 4) forming each of k columns among the stop plates 1Lₘₖᵢ (m=1 to 4) (k=1 to 4) (i=1 to 3) are supported by a support bar 7Lₖᵢ which extends through the center of the stop plates 1Lₘₖᵢ (m=1 to 4) and the reinforcing plates PRWB in height H1 direction. The lower end of the support bar 7Lₖᵢ is fitted in a hole of the wall WLD. The upper end of the support bar 7Lₖᵢ is fitted in a hole of the wall WLU. The stop plate 1Lₘₖᵢ can rotate clockwise and counterclockwise about the support bar 7Lₖᵢ.

Similarly, in a position backward away from an inlet of the flow channel RCH within the flow channel RCH of the side piston 130R, 16 stop plates 1Rₘₖ₁ (m=1 to 4) (k=1 to 4) are arranged in a matrix with 4 rows and 4 columns. In a position backward away from the stop plates 1Rₘₖ₁ (m=1 to 4) (k=1 to 4) within the flow channel RCH, 16 stop plates 1Rₘₖ₂ (m=1 to 4) (k=1 to 4) are arranged in a matrix with 4 rows and 4 columns. In a position backward away from the stop plates 1Rₘₖ₂ (m=1 to 4) (k=1 to 4) within the flow channel RCH, 16 stop plates 1Rₘₖ₃ (m=1 to 4) (k=1 to 4) are arranged in a matrix with 4 rows and 4 columns. To each stop plate 1Rₘₖᵢ (m=1 to 4) (k=1 to 4) (i=1 to 3), three reinforcing plates PRWB orthogonal thereto are fixed. Four stop plates 1Rₘₖᵢ (m=1 to 4) forming each of k columns among the stop plates 1Rₘₖᵢ (m=1 to 4) (k=1 to 4) (i=1 to 3) are supported by a support bar 7Rₖᵢ which extends through the center of the stop plates 1Rₘₖᵢ (m=1 to 4) and the reinforcing plates PRWB in height H1 direction. The lower end of the support bar 7Rₖᵢ is fitted in a hole of the wall WRD. The upper end of the support bar 7Rₖᵢ is fitted in a hole of the wall WRU. The stop plate 1Rₘₖᵢ can rotate clockwise and counterclockwise about the support bar 7Rₖᵢ.

The volume of the flow channel CCH of the center piston 120 equals to the total volume of the flow channels LCH, RCH of the side pistons 130L, 130R. Further, the cross sectional area of a cross section of the flow channel CCH of the center piston 120, the cross section of which is orthogonal to an extending direction of the flow channel CCH equals to the total cross sectional area of cross sections of the flow channels LCH, RCH of the side pistons 130L, 130R, the cross sections of which are orthogonal to extending directions of the flow channels LCH, RCH.

A drive mechanism 10CL₁ is provided on the upper surface of the wall WCU of the center piston 120 in a position just above the stop plates 1Cₘ₅₁ (m=1 to 4), 1Cₘ₆₁ (m=1 to 4), 1Cₘ₇₁ (m=1 to 4), 1Cₘ₈₁ (m=1 to 4). A drive mechanism 10CL₂ is provided on the upper surface of the wall WCU of the center piston 120 in a position just above the stop plates 1Cₘ₅₂ (m=1 to 4), 1Cₘ₆₂ (m=1 to 4), 1Cₘ₇₂ (m=1 to 4), 1Cₘ₈₂ (m=1 to 4). A drive mechanism 10CL₃ is provided on the upper surface of the wall WCU of the center piston 120 in a position just above the stop plates 1Cₘ₅₃ (m=1 to 4), 1Cₘ₆₃ (m=1 to 4), 1Cₘ₇₃ (m=1 to 4), 1Cₘ₈₃ (m=1 to 4).

A drive mechanism 10CR₁ is provided on the upper surface of the wall WCU of the center piston 120 in a position just above the stop plates 1Cₘ₁₁ (m=1 to 4), 1Cₘ₂₁ (m=1 to 4), 1Cₘ₃₁ (m=1 to 4), 1Cₘ₄₁ (m=1 to 4). A drive mechanism 10CR₂ is provided on the upper surface of the wall WCU of the center piston 120 in a position just above the stop plates 1Cₘ₁₂ (m=1 to 4), 1Cₘ₂₂ (m=1 to 4), 1Cₘ₃₂ (m=1 to 4), 1Cₘ₄₂ (m=1 to 4). A drive mechanism 10CR₃ is provided on the upper surface of the wall WCU of the center piston 120 in a position just above the stop plates 1Cₘ₁₃ (m=1 to 4), 1Cₘ₂₃ (m=1 to 4), 1Cₘ₃₃ (m=1 to 4), 1Cₘ₄₃ (m=1 to 4).

A drive mechanism 10LL₁ is provided on the upper surface of the wall WLU of the side piston 130L in a position just above the stop plates 1Lₘ₁₁ (m=1 to 4). A drive mechanism 10LL₂ is provided on the upper surface of the wall WLU of the side piston 130L in a position just above the stop plates 1Lₘ₁₂ (m=1 to 4). A drive mechanism 10LL₃ is provided on the upper surface of the wall WLU of the side piston 130L in a position just above the stop plates 1Lₘ₁₃ (m=1 to 4).

A drive mechanism 10RR₁ is provided on the upper surface of the wall WRU of the side piston 130R in a position just above the stop plates 1Rₘ₁₁ (m=1 to 4). A drive mechanism 10RR₂ is provided on the upper surface of the wall WRU of the side piston 130R in a position just above the stop plates 1Rₘ₁₂ (m=1 to 4). A drive mechanism 10RR₃ is provided on the upper surface of the wall WRU of the side piston 130R in a position just above the stop plates 1Rₘ₁₃ (m=1 to 4).

The drive mechanisms 10CLᵢ (i=1 to 3) and 10CRᵢ (i=1 to 3) of the center piston 120 are mechanisms which move the stop plates 1Cₘₙᵢ (m=1 to 4) (n=1 to 8) (i=1 to 3) within the center piston 120 so that a range between a first position PF (see FIG. 1) and a second position PB (see FIG. 1) posterior to the position PF is a range of forward and backward movement of the center piston 120 in the inside movement space SP_{IN}, water flow resistance R_{IN} of the stop plates 1Cₘₙᵢ (m=1 to 4) (n=1 to 8) (i=1 to 3) within the center piston 120 becomes smaller when the center piston 120 moves backward from the position PF to the position PB, and water flow resistance R_{IN} of the stop plates 1Cₘₙᵢ (m=1 to 4) (n=1 to 8) (i=1 to 3) within the center piston 120 becomes larger when the center piston 120 moves forward from the position PB to the position PF.

The drive mechanisms 10LLᵢ (i=1 to 3) and 10RRᵢ (i=1 to 3) of the side pistons 130L and 130R are mechanisms which move the stop plates 1Lₘₖᵢ (m=1 to 4) (k=1 to 4) (i=1 to 3) and 1Lₘₖᵢ (m=1 to 4) (k=1 to 4) (i=1 to 3) within the side pistons 130L and 130R so that a range between the position PF and the position PB is a movement range of the side pistons 130L and 130R in the outside movement spaces SP_{OUT}, water flow resistance R_{OUT} of the stop plates 1Lₘₖᵢ (m=1 to 4) (k=1 to 4) (i=1 to 3) and 1Lₘₖᵢ (m=1 to 4) (k=1 to 4) (i=1 to 3) within the side pistons 130L and 130R becomes smaller when the side pistons 130L and 130R move backward from the position PF to the position PB, and water flow resistance R_{OUT} of the stop plates 1Lₘₖᵢ (m=1 to 4) (k=1 to 4) (i=1 to 3) and 1Lₘₖᵢ (m=1 to 4) (k=1 to 4) (i=1 to 3) within the side pistons 130L and 130R becomes larger when the side pistons 130L and 130R move forward from the position PB to the position PF. The drive mechanisms 10CLᵢ (i=1 to 3), 10CRᵢ (i=1 to 3), 10LLᵢ (i=1 to 3), and 10RRᵢ (i=1 to 3) will be described in detail later.

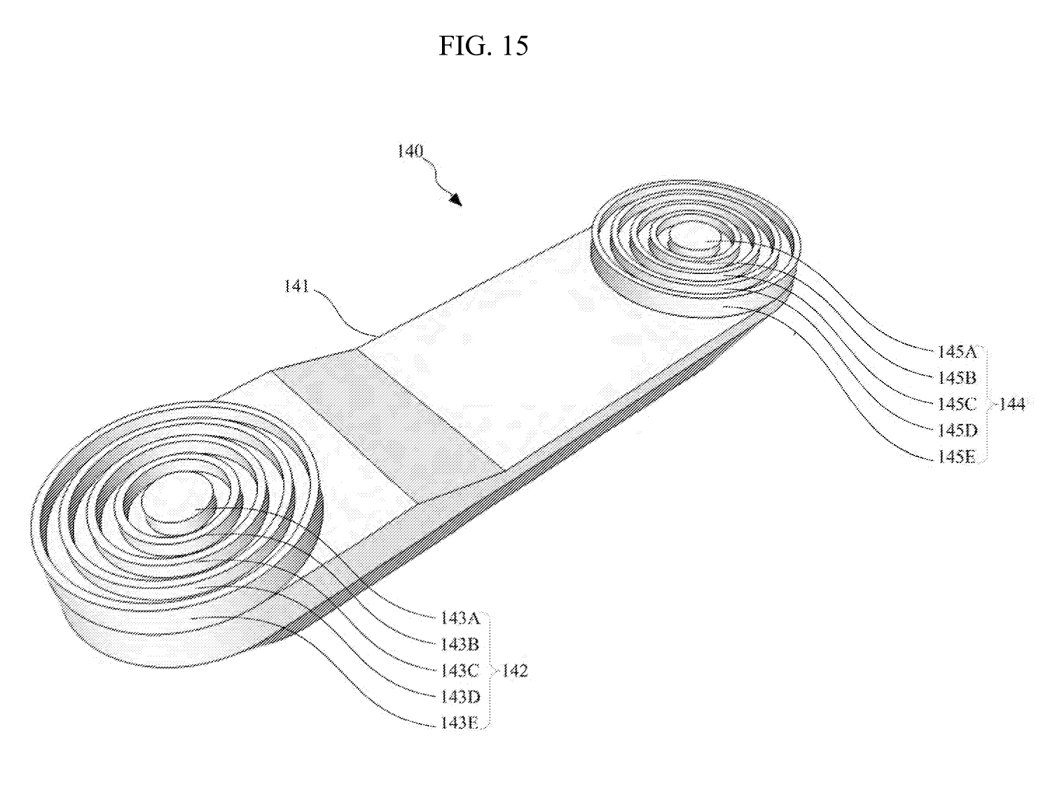

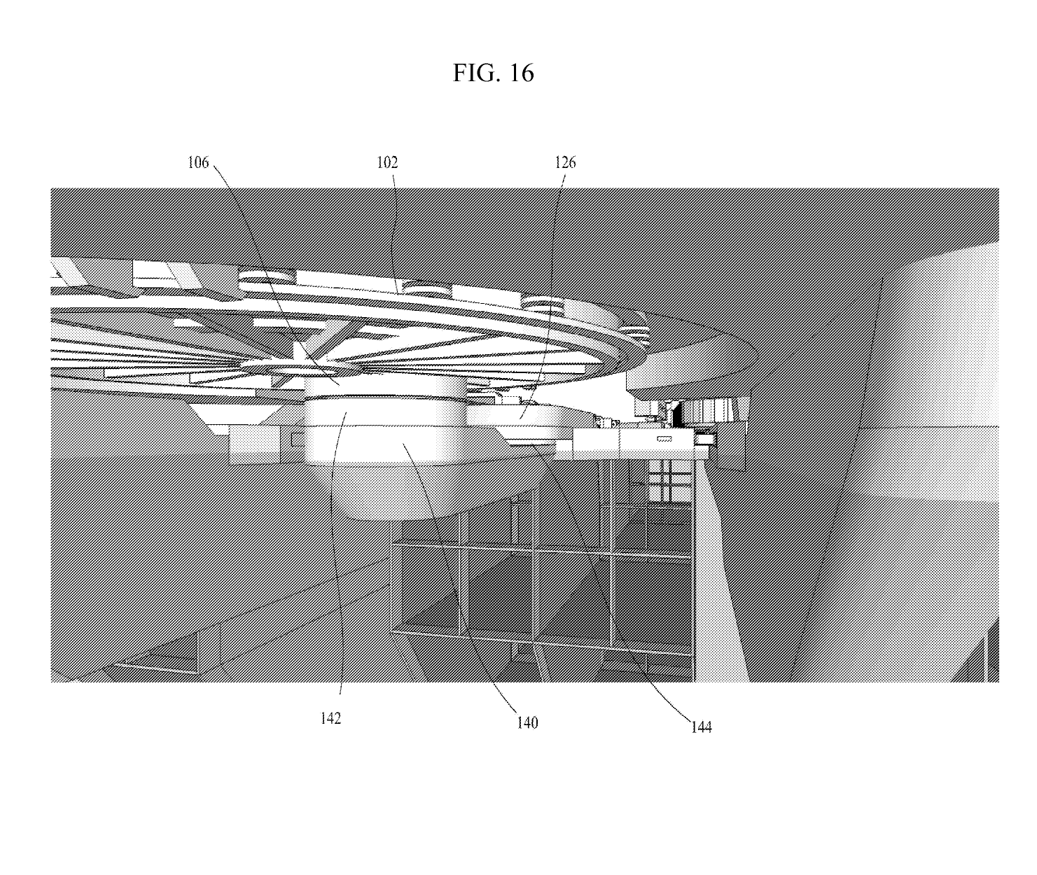

FIG. 15 is a perspective view of the crank ship 140. The crank ship 140 has a connecting portion 142 and a connecting portion 144 provided at one end and the other end on the upper surface of an enclosure 141 that extends in one direction. The connecting portion 142 has a columnar cylindrical wall 143A sized to be within the most inner cylindrical wall of the connecting portion 106, a cylindrical wall 143B sized to be within the second most inner cylindrical wall of the connecting portion 106, a cylindrical wall 143C sized to be within the third most inner cylindrical wall of the connecting portion 106, a cylindrical wall 143D sized to be within the forth most inner cylindrical wall of the connecting portion 106, and a cylindrical wall 143E sized to be slightly larger than the forth most inner cylindrical wall of the connecting portion 106. The connecting portion 144 has a columnar cylindrical wall 145A sized to be within the most inner cylindrical wall of the connecting portion 126, a cylindrical wall 145B sized to be within the second most inner cylindrical wall of the connecting portion 126, a cylindrical wall 145C sized to be within the third most inner cylindrical wall of the connecting portion 126, a cylindrical wall 145D sized to be within the forth most inner cylindrical wall of the connecting portion 126, and a cylindrical wall 144E sized to be slightly larger than the forth most inner cylindrical wall of the connecting portion 126. As shown in FIG. 16, the connecting portion 142 of the crank ship 140 is connected to the connecting portion 106 of the rotating disk 102. The connecting portion 144 of the crank ship 140 is connected to the connecting portion 126 of the center piston 120.

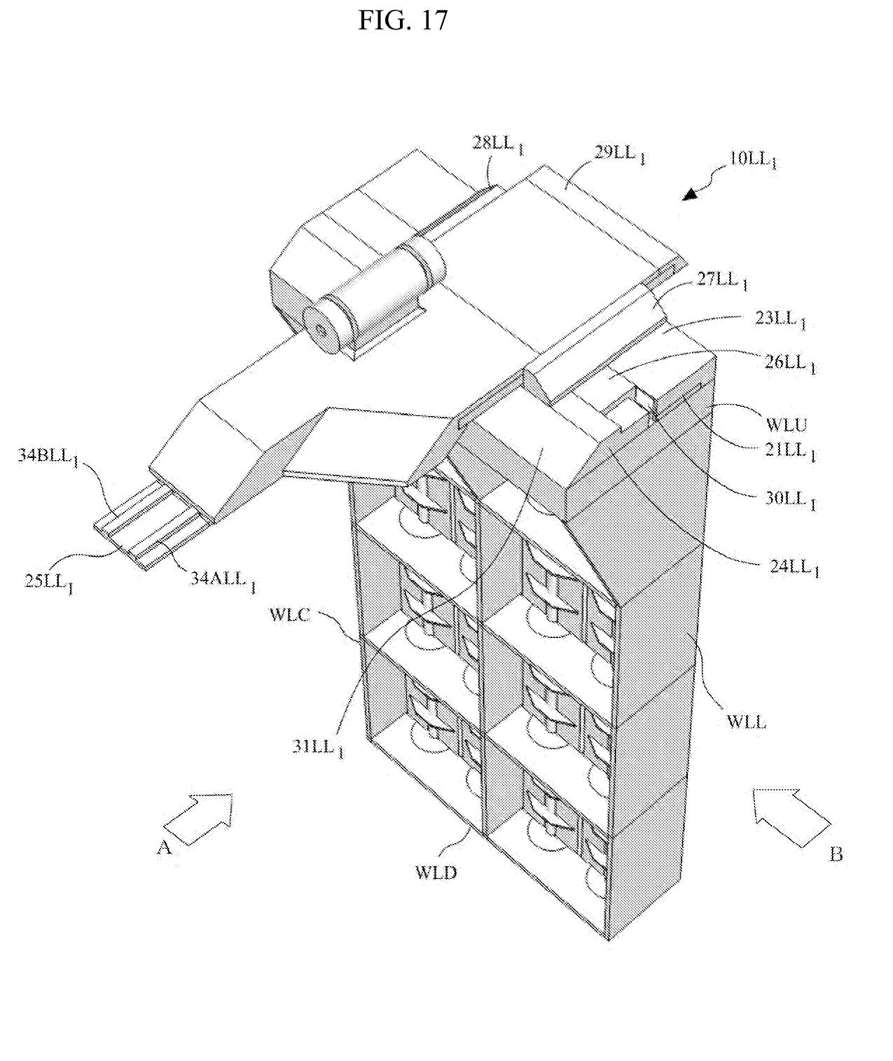

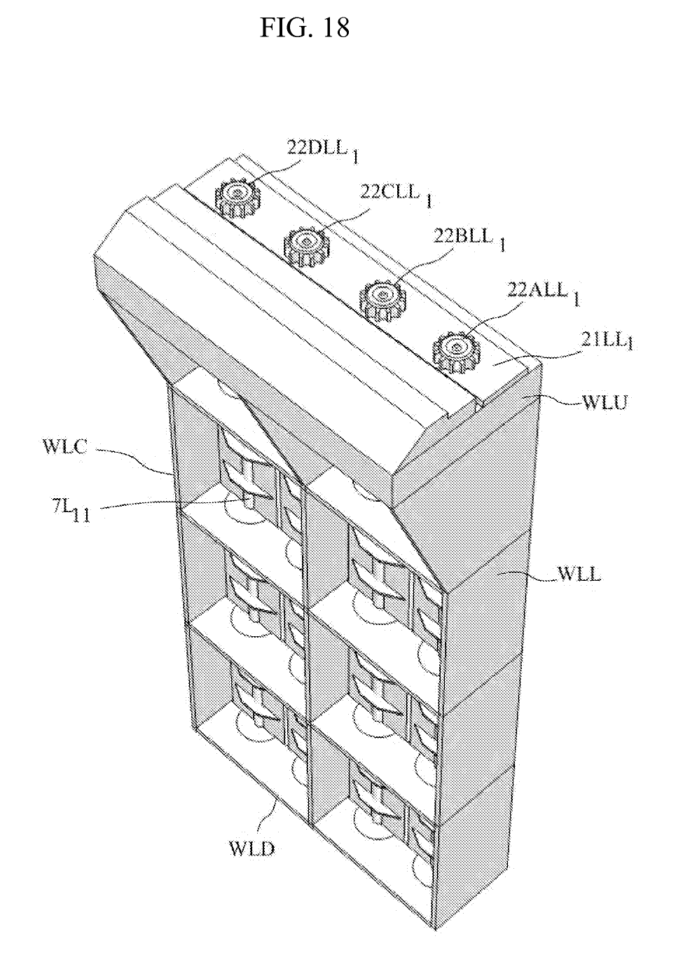

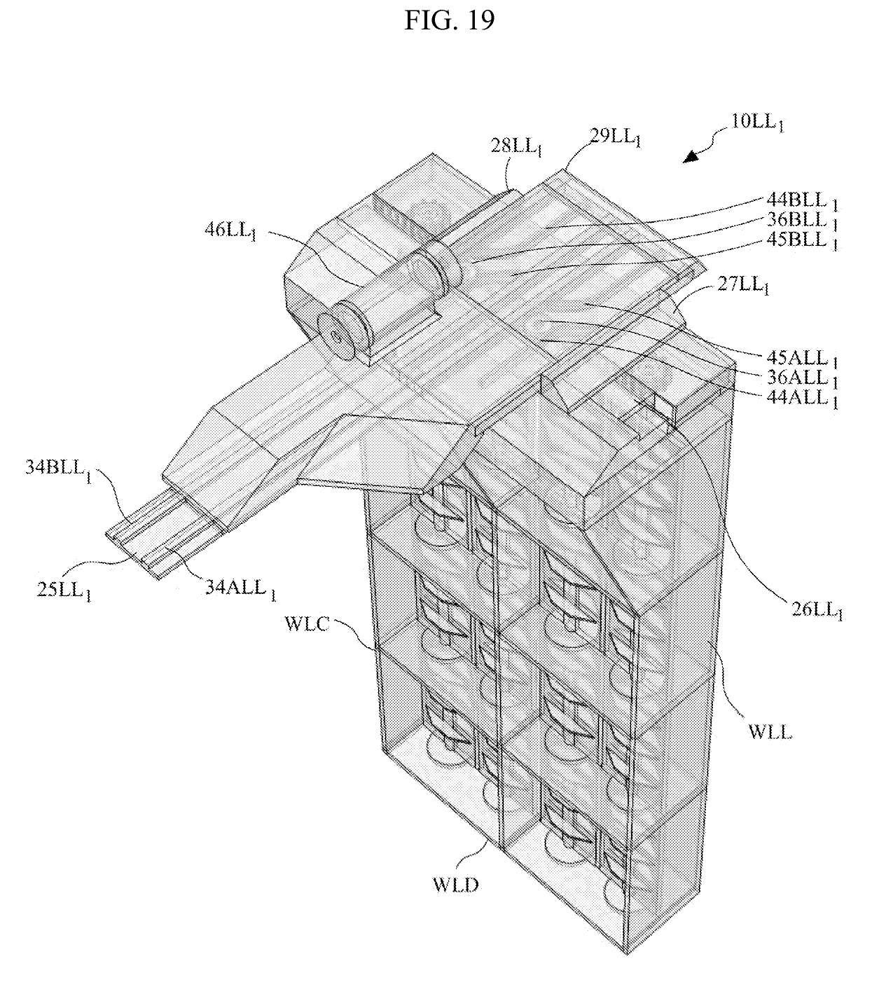

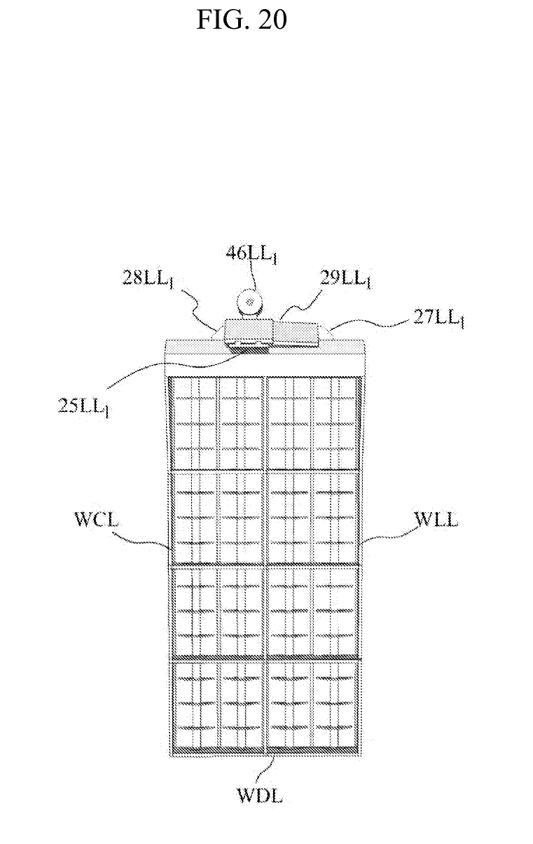

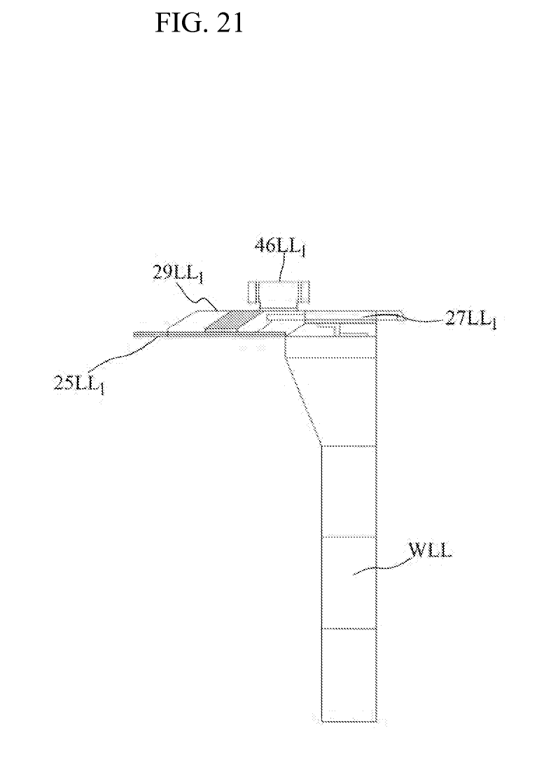

A configuration of the drive mechanism 10LL₁, which is one of the drive mechanisms 10CLᵢ (i=1 to 3), 10CRᵢ (i=1 to 3), 10LLᵢ (i=1 to 3), 10RRᵢ (i=1 to 3), and taken therefrom as an example, will be described below. FIG. 17 is a perspective view of the stop plates 1Lₘₖ₁ (m=1 to 4) (k=1 to 4) in the flow channel LCH and the drive mechanism 10LL₁ in the side piston 130L. FIG. 18 is a diagram illustrating a state where some components of the drive mechanism 10LL₁ are removed from FIG. 17. FIG. 19 is a transparent view of FIG. 17. FIG. 20 is a diagram of FIG. 17 viewed from arrow A direction (front view). FIG. 21 is a diagram of FIG. 17 viewed from arrow B direction (side view). As shown in FIG. 18, the support bars 7Lₖᵢ (k=1 to 4) which support the stop plates 1Lₘₖᵢ (m=1 to 4) (k=1 to 4) extend through the wall WLU and a medium plate 21LL₁ fixed on the upper surface of the wall WLU and reach above the medium plate 21LL₁, and gears 22ALL₁, 22BLL₁, 22CLL₁, 22DLL₁, are pivotally mounted to portions of the respective support bars Lₖᵢ (k=1 to 4) above the medium plate 21LL₁. The drive mechanism 10LL₁ has these gears 22ALL₁, 22BLL₁, 22CLL₁, 22DLL₁, a cover portion 23LL₁, a guide portion 24LL₁, a slide portion 26LL₁, a rail portion 25LL₁, guide portions 27LL₁ and 28LL₁, and a slide portion 29LL₁.

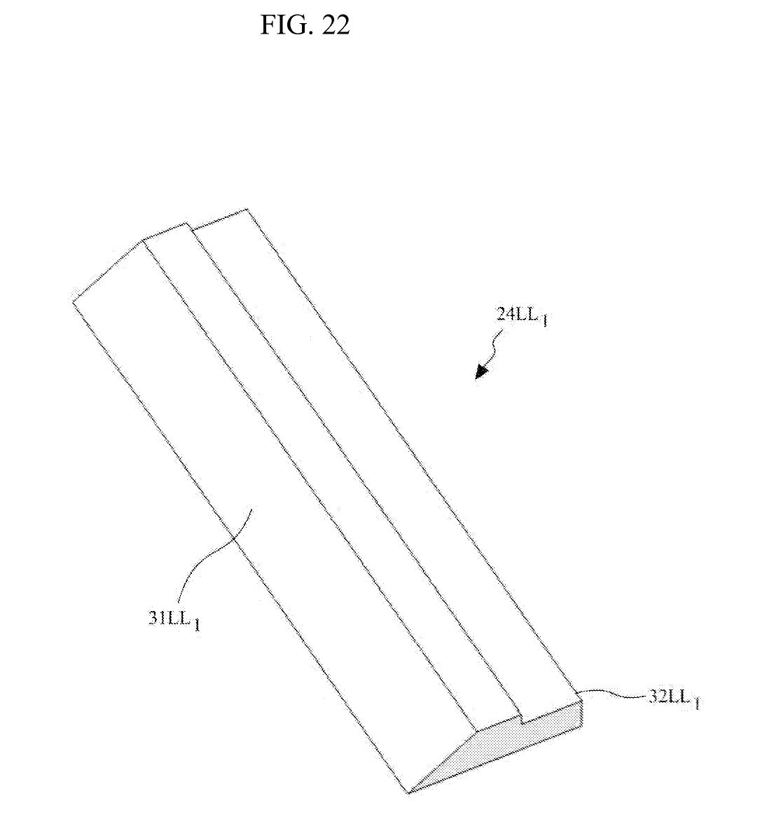

More specifically, the upper, back, and lateral sides of the gears 22ALL₁, 22BLL₁, 22CLL₁, 22DLL₁ are covered by the cover portion 23LL₁. There is a rectangular-shaped opening 30LL₁ in the front of the cover portion 23LL₁. The gears 22ALL₁, 22BLL₁, 22CLL₁, 22DLL₁, are partially exposed from the opening 30LL₁. There is the guide portion 24LL₁ in front of the cover portion 23LL₁. FIG. 22 is a perspective view of the guide portion 24LL₁. As shown in FIG. 22, the guide portion 24LL₁ has a shape in which the front face 31LL₁ of the plate extending in width W1 direction is a downwardly inclined tapered surface, and its rear part is cut out to be stepped.

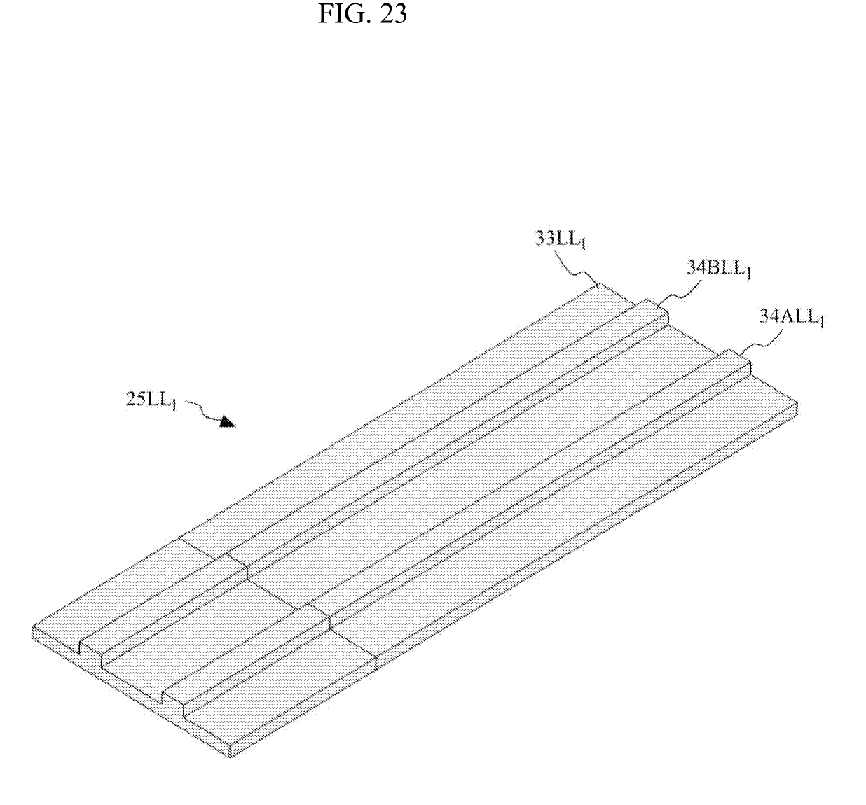

The rear face 32LL₁ of the guide portion 24LL₁ opposes the opening 30LL₁ of the cover portion 23LL₁ across a gap. In front of a position deviated slightly from the center of width W1 direction, of the tip portion of the front face 31LL₁ of the guide portion 24LL₁, there is the rail portion 25LL₁ which extends forward from the position as a base end. FIG. 23 is a schematic view of the rail portion 25LL₁. As shown in FIG. 23, there are protruding portions 34ALL₁ and 34BLL₁ which protrude upward on the upper surface 33LL₁ of the rail portion 25LL₁. The protruding portions 34ALL₁ and 34BLL₁ extend in parallel with the extending direction of the rail portion 25LL₁ itself. There is a space in width W1 direction between the protruding portions 34ALL₁ and 34BLL₁.

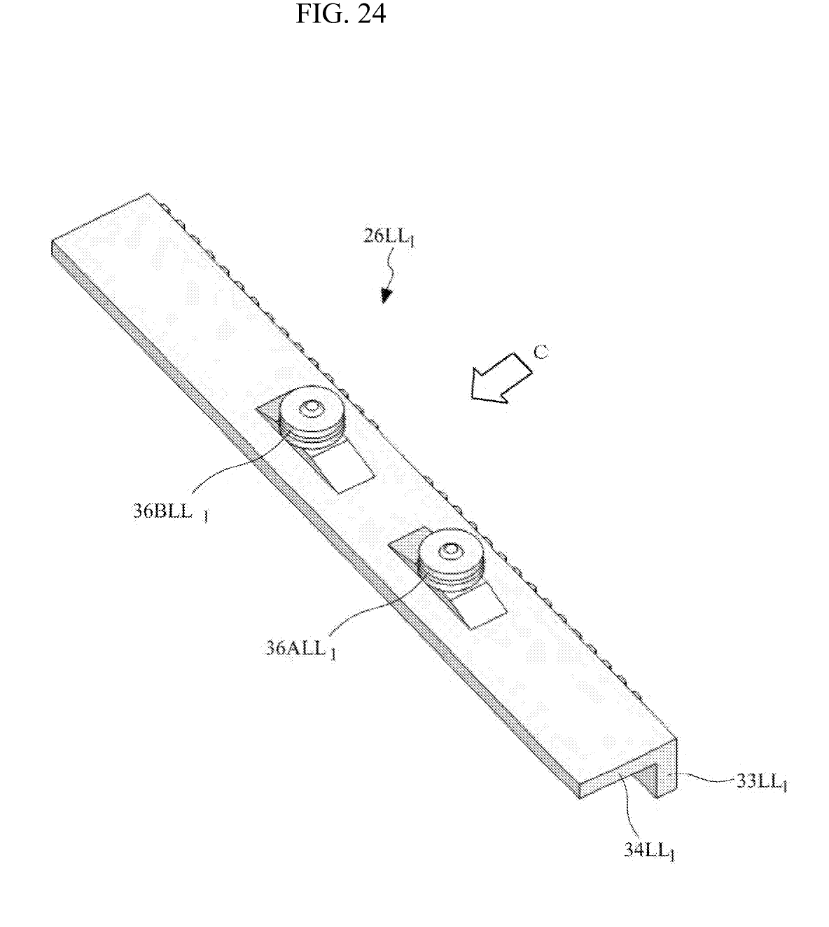

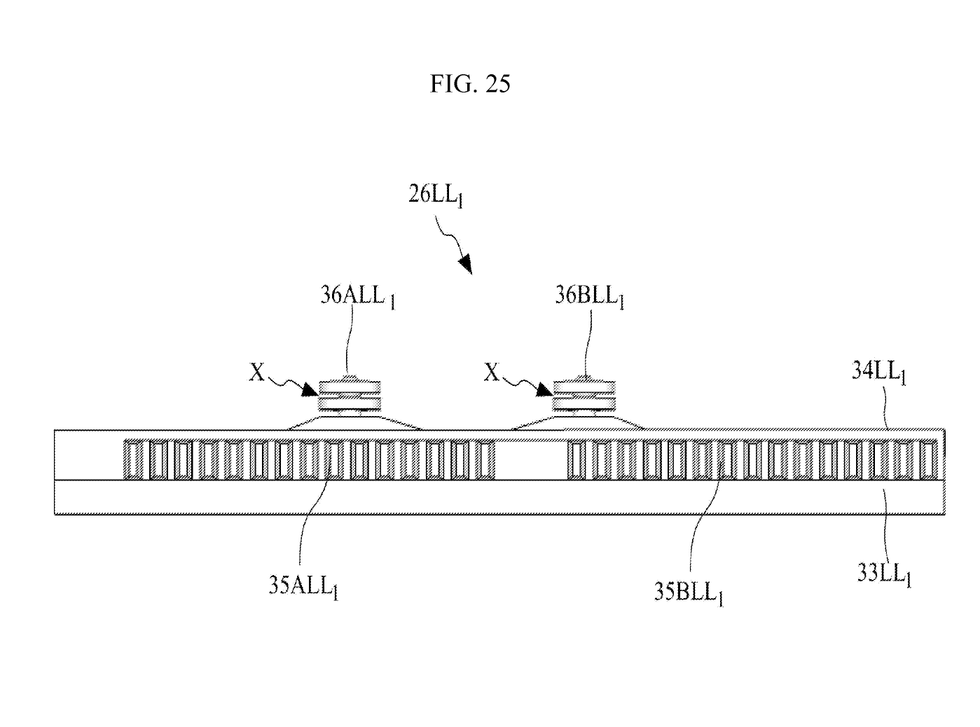

The slide portion 26LL₁ is fitted in the gap between the rear face 32LL₁ of the guide portion 24LL₁ and the opening 30LL₁ of the cover portion 23LL₁. FIG. 24 is a perspective view of the slide portion 26LL₁. FIG. 25 is a diagram of FIG. 24 viewed from arrow C direction. As shown in FIG. 24 and FIG. 25, the slide portion 26LL₁ is formed of two plates 33LL₁ and 34LL₁ intersected in an L-shape. The size of the slide portion 26LL₁ in width W1 direction is slightly smaller than those of the cover portion 23LL₁ and the guide portion 24LL₁.

Linear gears 35ALL₁ and 35BLL₁ are formed on the upper surface of the plate 33LL₁ of the slide portion 26LL₁. Two wheels 36ALL₁ and 36BLL₁ are pivotally mounted on the upper surface of the plate 34LL₁ of the slide portion 26LL₁. The two wheels 36ALL₁ and 36BLL₁ are spaced apart in width W1 direction. There are recessed portions X that are narrow circularly in the middle position in height H1 direction of sides of the wheels 36ALL₁ and 36BLL₁.

In a state where the slide portion 26LL₁ is fitted in the gap between the rear face 32LL₁ of the guide portion 24LL₁ and the opening 30LL₁ of the cover portion 23LL₁, the linear gear 35ALL₁ engages with an exposed portion of the gears 22ALL₁, 22BLL₁ within the cover portion 23LL₁ through the opening 30LL₁, and the linear gear 35BLL₁ engages with an exposed portion of the gears 22CLL₁, 22DLL₁ within the cover portion 23LL₁ through the opening 30LL₁. Further, in this state, the upper surface of the plate 34LL₁ of the slide portion 26LL₁, the upper surface of the guide portion 24LL₁, and the upper surface of the cover portion 23LL₁ are flush with one another. Further, in this state, the slide portion 26LL₁ contacts with the guide portion 24LL₁ with a weak frictional force to the extent that the slide portion 26LL₁ can slide on the guide portion 24LL₁ in width W1 direction.

As shown in FIG. 17, there are the guide portions 27LL₁ and 28LL₁ on the guide portion 24LL₁ and the cover portion 23LL₁. One of two sides perpendicular to each other of each of the guide portions 27LL₁ and 28LL₁ is fixed to the upper surface of the guide portion 24LL₁, and the upper surface of the cover portion 23LL₁. The other side of the guide portions 27LL₁ and the other side of the guide portions 28LL₁ oppose at an interval in width W1 direction.

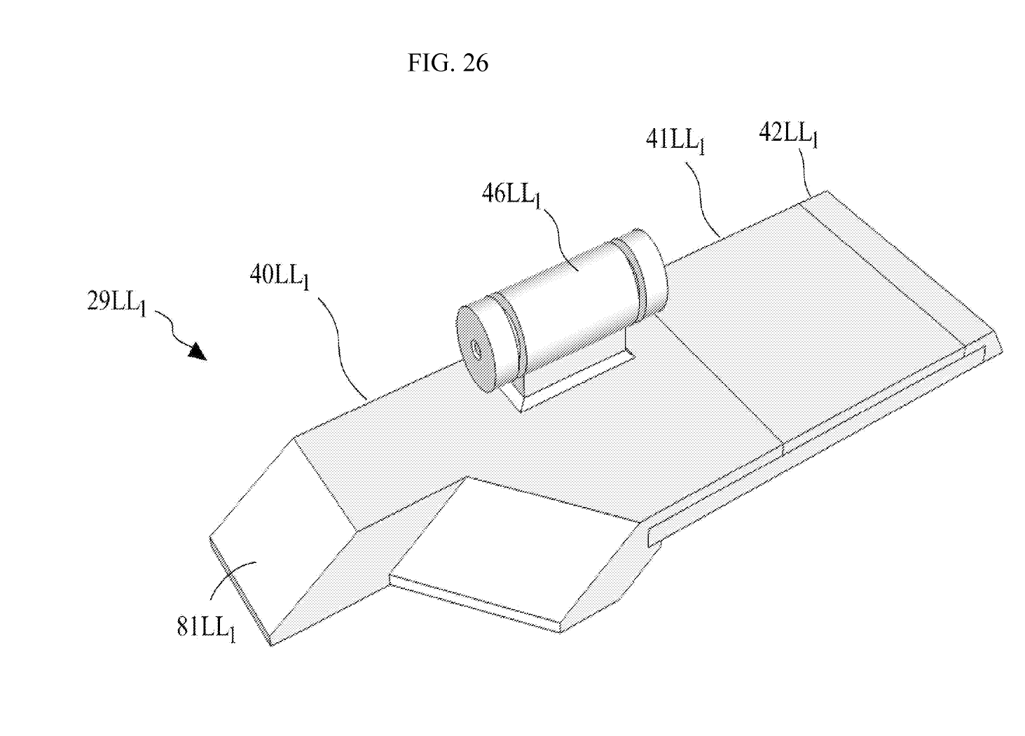

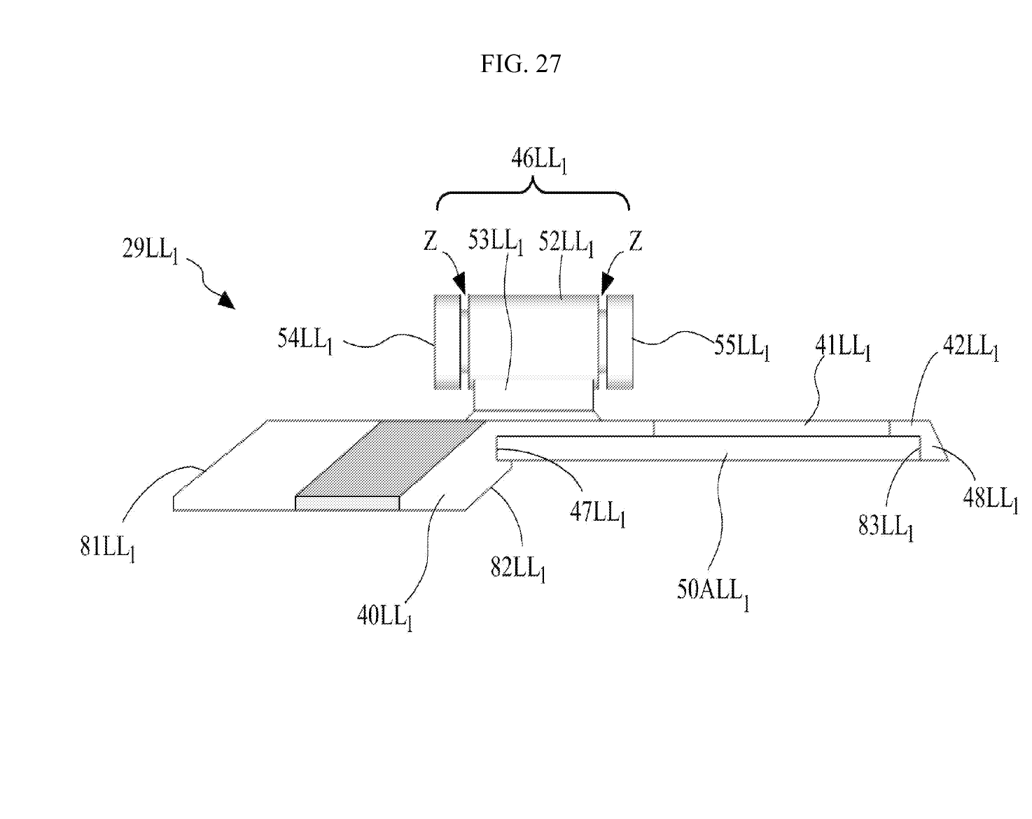

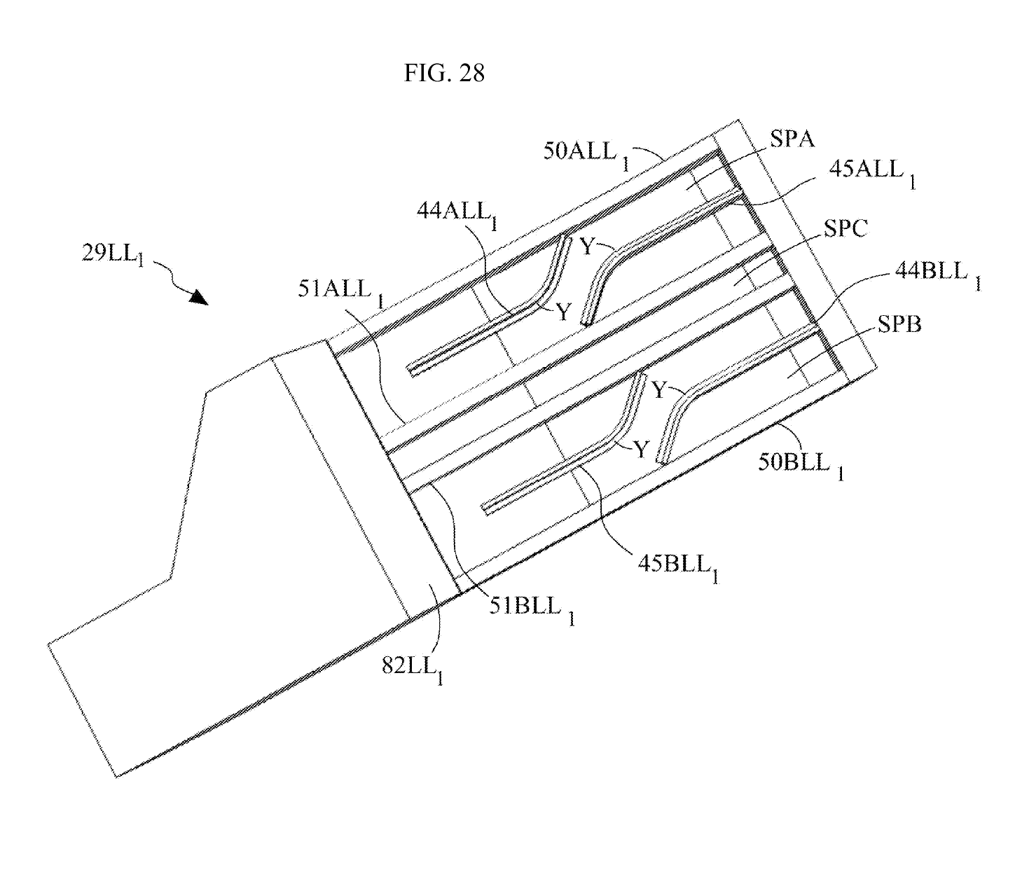

The slide portion 29LL₁ is fitted in between the guide portions 27LL₁ and the guide portions 28LL₁. FIG. 26 is a perspective view of the slide portion 29LL₁. FIG. 27 is a left side view of FIG. 26. FIG. 28 is a bottom view of FIG. 26. As shown in FIG. 26, FIG. 27, and FIG. 28, the slide portion 29LL₁ includes a front plate 40LL₁, a middle plate 41LL₁, and a back plate 42LL₁ which are arranged and connected in the forward and backward direction; side plates 50ALL₁, 50BLL₁, 51ALL₁, 51BLL₁ and curved plates 44ALL₁, 44BLL₁, 45ALL₁, 45BLL₁ which are fixed to the lower surface of the plates 40LL₁, 41LL₁, and 42LL₁; and a hammer portion 46LL₁ fixed to the upper surface of the front plate 40LL₁.

The first half portion of the front plate 40LL₁ is formed to be wider than the latter half portion. The upper and lower surfaces of the first half portion of the front plate 40LL₁ are shaped like a rectangular from which one corner is cut out. A front face 81LL₁ and a rear face 82LL₁ of the first half portion of the front plate 40LL₁ form tapered surfaces. The inclination angle of the front face 81LL₁ and the rear face 82LL₁ of the front plate 40LL₁ is the same as the inclination angle of the front face 31LL₁ of the rail portion 25LL₁. An upper edge of the rear face 82LL₁ of the front plate 40LL₁ is cut out forward to form a recessed portion 47LL₁. The latter half potion of the front plate 40LL₁ extends backward from a portion above the recessed portion 47LL₁ as a base end. The forward end of the middle plate 41LL₁ is fixed to the back end of the latter half portion of the front plate 40LL₁. The forward end of the back plate 42LL₁ is fixed to the back end of the middle plate 41LL₁. The lower surface of the latter half portion of the front plate 40LL₁, the lower surface of the middle plate 41LL₁, and the lower surface of the back plate 42LL₁ are flush with one another.

The back end of the back plate 42LL₁ is bent downward as a protruding edge portion 48LL₁. The inner surface 83LL₁ of the protruding edge portion 48LL₁ is orthogonal to the lower surface of the back plate 42LL₁. The side plates 50ALL₁, 50BLL₁, 51ALL₁, 51BLL₁ are inserted between the inner surface 83LL₁ and the recessed portion 47LL₁. The size of the side plates 50ALL₁, 50BLL₁, 51ALL₁, 51BLL₁ in height H1 direction is the same as that of the recessed portion 47LL₁. The forward ends of the side plates 50ALL₁, 50BLL₁, 51ALL₁, 51BLL₁ are fitted in the recessed portion 47LL₁. The back ends of the side plates 50ALL₁, 50BLL₁, 51ALL₁, 51BLL₁ abut on the inner surface 83LL₁. The upper surfaces of the side plates 50ALL₁, 50BLL₁, 51ALL₁, 51BLL₁ abut on the lower surface of the latter half portion of the front plate 40LL₁, the lower surface of the middle plate 41LL₁, and the lower surface of the back plate 42LL₁.

A thin space sandwiched between the recessed portion 47LL₁ and the inner surface 83LL₁ in the forward and backward direction under the lower surfaces of the latter half portion of the front plate 40LL₁, the middle plate 41LL₁, and the back plate 42LL₁ are divided by the side plates 50ALL₁, 50BLL₁, 51ALL₁, 51BLL₁ into three spaces SPA, SPB, SPC. The size in width W1 direction of the left and right spaces SPA, SPB among the spaces SPA, SPB, SPC is wider than that of the middle space SPC. There are the curved plates 44ALL₁ and 45ALL₁ within the space SPA. There are the curved plates 44BLL₁ and 45BLL₁ within the space SPB. For each curved plate 44ALL₁, 44BLL₁, 45ALL₁, 45BLL₁ the center in height H1 direction of the inner surface of the curved plate is protruded as a protruding portion Y.

The upper surface of the curved plate 44ALL₁ abuts on the lower surface of the latter half portion of the front plate 40LL₁, the lower surface of the middle plate 41LL₁, and the lower surface of the back plate 42LL₁. The upper surface of the curved plate 45ALL₁ abuts on the lower surface of the latter half portion of the front plate 40LL₁, the lower surface of the middle plate 41LL₁, and the lower surface of the back plate 42LL₁. One end of the curved plate 44ALL₁ faces toward the rear face 82LL₁, and the other end of the curved plate 44ALL₁ is in contact with the side plate 50ALL₁. One end of the curved plate 45ALL₁ is in contact with the inner surface 83LL₁ of the back plate 42LL₁, and the other end of the curved plate 45ALL₁ is in contact with the side plate 51ALL₁. A portion of the curved plate 44ALL₁ bent toward the side plate 51ALL₁ and a portion of the curved plate 45ALL₁ bent toward the side plate 50ALL₁ face to each other in parallel with a space therebetween in a direction at an approximately 45 degrees relative to the forward and backward direction.

The upper surface of the curved plate 44BLL₁ abuts on the lower surface of the latter half portion of the front plate 40LL₁, the lower surface of the middle plate 41LL₁, and the lower surface of the back plate 42LL₁. The upper surface of the curved plate 45BLL₁ abuts on the lower surface of the latter half portion of the front plate 40LL₁, the lower surface of the middle plate 41LL₁, and the lower surface of the back plate 42LL₁. One end of the curved plate 45BLL₁ faces toward the rear face 82LL₁, and the other end of the curved plate 45BLL₁ is in contact with the side plate 51BLL₁. One end of the curved plate 44BLL₁ is in contact with the inner surface 83LL₁ of the back plate 42LL₁, and the other end of the curved plate 44BLL₁ is in contact with the side plate 50BLL₁. A portion of the curved plate 45BLL₁ bent toward the side plate 51BLL₁ and a portion of the curved plate 44BLL₁ bent toward the side plate 50BLL₁ face to each other in parallel with a space therebetween in a direction at an approximately 45 degrees relative to the forward and backward direction.

There is the hammer portion 46LL₁ on the upper surface of the front plate 40LL₁ in a position backward away from an intersection of the upper surface of the front plate 40LL₁ and the front face 81LL₁. The hammer portion 46LL₁ has a cylinder portion 52LL₁ and a pedestal portion 53LL₁. A front face 54LL₁ and a rear face 55LL₁ of the cylinder portion 52LL₁ have a pore at the center of them. In addition, there is a circularly narrow recessed portion Z in a position slightly posterior to the front face 54LL₁ and a position slightly anterior to the rear face 55LL₁ on the side face of the cylinder portion 52LL₁. The side face of the cylinder portion 52LL₁ is fixed to the pedestal portion 53LL₂, and the pedestal portion 53LL₁ is fixed to the upper surface of the front plate 40LL₁.

As shown in FIG. 19, in a state where the slide portion 29LL₁ is fitted in between the guide portion 27LL₁ and the guide portion 28LL₂, the slide portion 29LL₁ covers the wheels 36ALL₁ and 36BLL₁ of the slide portion 26LL₁. The wheel 36ALL₁ is sandwiched between the curved plates 44ALL₁ and 45ALL₁ of the slide portion 29LL₁, and the protruding portions Y of the curved plates 44ALL₁ and 45ALL₁ are fitted in the recessed portion X of the wheel 36ALL₁. The wheel 36BLL₁ is sandwiched between the curved plates 44BLL₁ and 45BLL₁ of the slide portion 29LL₁, and the protruding portions Y of the curved plates 44BLL₁ and 45BLL₁ are fitted in the recessed portion X of the wheel 36BLL₁. Further, the slide portion 29LL₁ contacts with the protruding portions 34ALL₁ and 34BLL₁ with a weak frictional force to the extent that the slide portion 29LL₁ can slide on the protruding portions 34ALL₁ and 34BLL₁ of the rail portion 25LL₁.

The details of the configuration of the drive mechanism 10LL₁ were described above. Configurations of the drive mechanisms 10CLᵢ (i=1 to 3), 10CRᵢ (i=1 to 3), 10LL₂, 10LL₃, and 10RRᵢ (i=1 to 3) are the same as the configuration of the drive mechanism 10LL₁.

As shown in FIG. 1, the hammer portion 46CLᵢ of each drive mechanism 10CLᵢ of the drive mechanisms 10CLᵢ (i=1 to 3) is positioned between the receiving portions 6CLFᵢ and 6CLBᵢ of the framework 5Lᵢ. Further, the hammer portion 46CRᵢ of each drive mechanism 10CRᵢ of the drive mechanisms 10CRᵢ (i=1 to 3) is positioned between the receiving portions 6CRFᵢ and 6CRBᵢ of the framework 5Lᵢ. Further, the hammer portion 46LLᵢ of each drive mechanism 10LLᵢ of the drive mechanisms 10LLᵢ (i=1 to 3) is positioned between the receiving portions 6LLFᵢ and 6LLBᵢ of the framework 5Lᵢ. The hammer portion 46RRᵢ of each drive mechanism 10RRᵢ of the drive mechanisms 10RRᵢ (i=1 to 3) is positioned between the receiving portions 6RRFᵢ and 6RRBᵢ of the framework 5Rᵢ.

Because of the positional relationships between the hammer portions 46CLᵢ, 46CRᵢ, 46CLᵢ, and 46CRᵢ and the receiving portions 6CLFᵢ, 6CLBᵢ, 6CRFᵢ, 6CRBᵢ, 6CLFᵢ, 6CLBᵢ, 6CRFᵢ, and 6CRBᵢ as described above, the water flow generator 90 repeats the following operation: When the center piston 120 moves forward relative to the side pistons 130L, 130R, the stop plates 1Cₘₙᵢ (m=1 to 4) (n=1 to 8) (i=1 to 3) in the center piston 120 are closed, and the stop plates 1Lₘₖᵢ, 1Rₘₖᵢ (m=1 to 4) (k=1 to 4) (i=1 to 3) in the side pistons 130L, 130R are opened; and when the side pistons 130L, 130R move forward relative to the center piston 120, the stop plates 1Lₘₖᵢ, 1Rₘₖᵢ (m=1 to 4) (k=1 to 4) (i=1 to 3) in the side pistons 130L, 130R are closed, and the stop plates 1Cₘₙᵢ (m=1 to 4) (n=1 to 8) (i=1 to 3) in the center piston 120 are opened. The details of this operation will be described below.

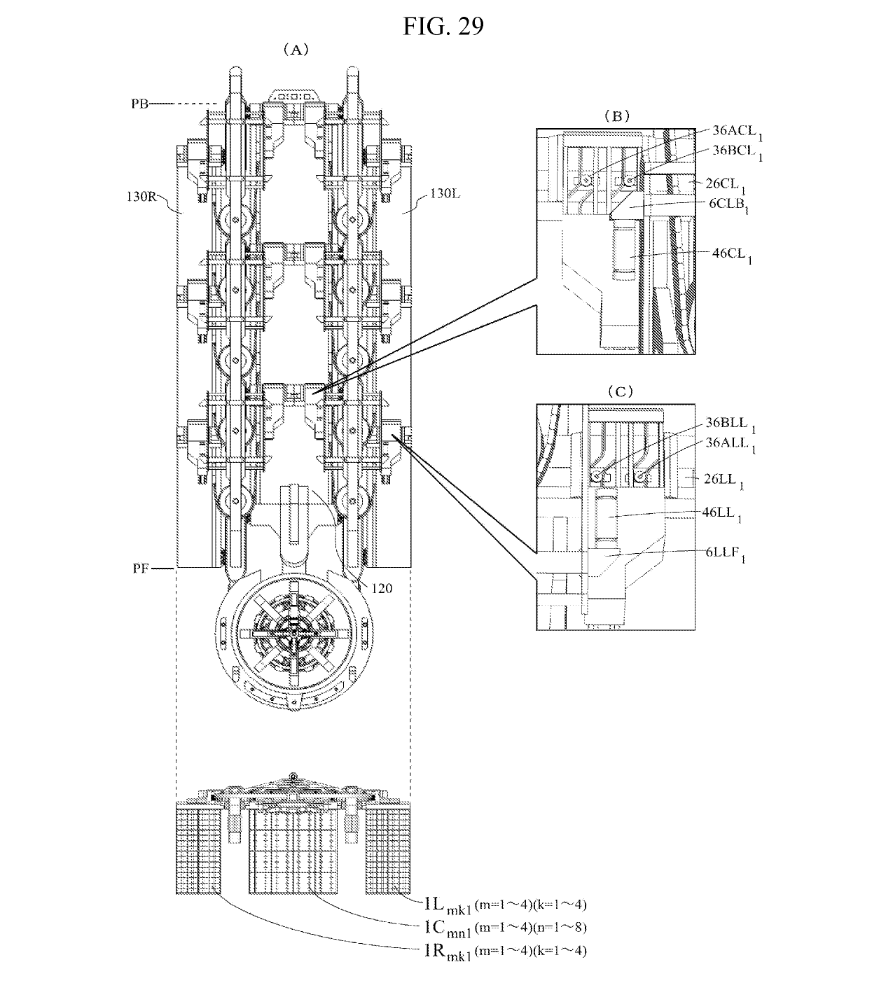

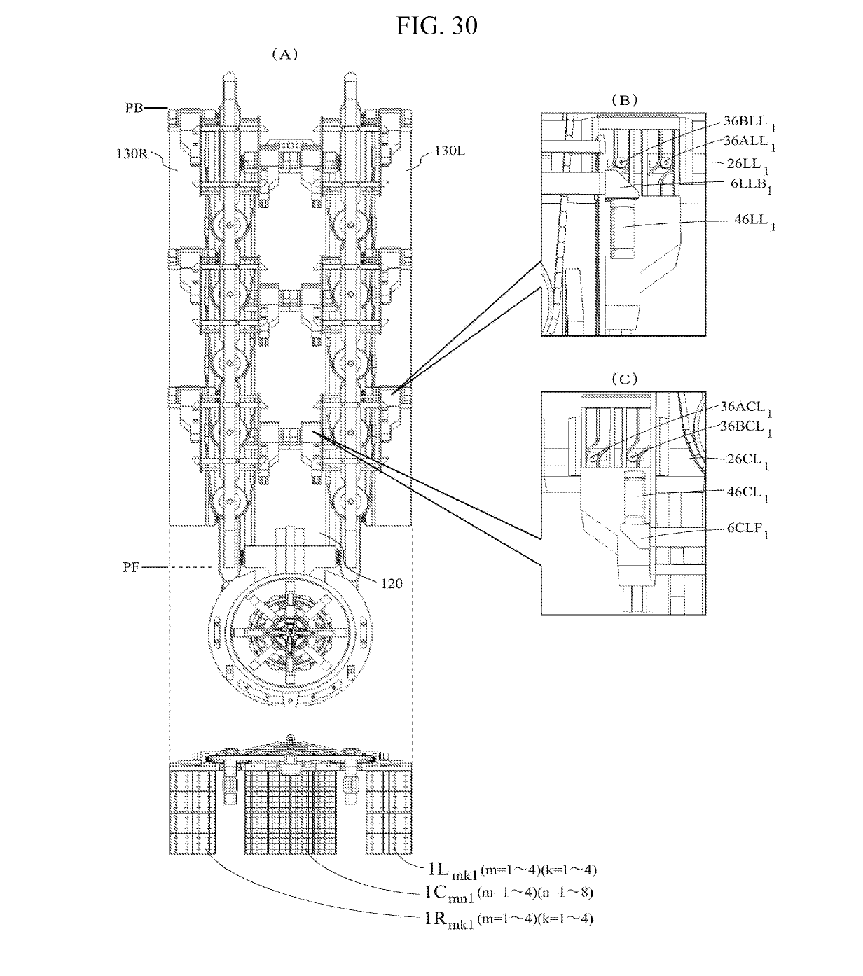

FIG. 29(A) is a top view and a front view of the water flow generator 90 in a state ST1 where the side pistons 130L, 130R are in the first position PF, and the center piston 120 is in the second position PB. FIG. 29(B) is a diagram in which the middle plate 41CL₁ of the drive mechanism 10CL₁ in the state ST1 is removed to expose the interior of the mechanism 10CL₁. FIG. 29(C) is a diagram in which the middle plate 41LL₁ of the drive mechanism 10LL₁ in the state ST1 is removed to expose the interior of the mechanism 10LL₁. FIG. 30(A) is a top view and a front view of the water flow generator 90 in a state ST2 where the side pistons 130L, 130R are in the second position PB and the center piston 120 is in the first position PF. FIG. 30(B) is a diagram in which the middle plate 41LL₁ of the drive mechanism 10LL₁ in the state ST2 is removed to expose the interior of the mechanism 10LL₁. FIG. 30(C) is a diagram in which the middle plate 41CL₁ of the drive mechanism 10CL₁ in the state ST2 is removed to expose the interior of the mechanism 10CL₁.

As shown in FIG. 29(A), in the state ST1, the stop plates 1Cₘₙᵢ (m=1 to 4) (n=1 to 8) (i=1 to 3) in the center piston 120 are open (directed in a direction parallel to the extending direction of the flow channel CCH in the center piston 120), and the stop plates 1Lₘₖᵢ (m=1 to 4) (k=1 to 4) (i=1 to 3), 1Rₘₖᵢ (m=1 to 4) (k=1 to 4) (i=1 to 3) in the side pistons 130L, 130R are closed (directed in a direction orthogonal to the extending directions of the flow channels LCH, RCH in the side pistons 130L, 130R). In the state ST1, the magnitude relationship between water flow resistance R_{IN} of the stop plates 1Cₘₙᵢ (m=1 to 4) (n=1 to 8) (i=1 to 3) in the center piston 120 and water flow resistance R_{OUT} of the stop plates 1Lₘₖᵢ (m=1 to 4) (k=1 to 4) (i=1 to 3), 1Rₘₖᵢ (m=1 to 4) (k=1 to 4) (i=1 to 3) in the side pistons 130L, 130R is R_{IN}<R_{OUT}, and the magnitude relationship between a force of flowing water F_{IN} that pushes the center piston 120 backward and a force of flowing water F_{OUT} that pushes the side pistons 130L, 130R backward is F_{IN}<F_{OUT}. Accordingly, in the state ST1, the side pistons 130L, 130R move backward while pulling ends of the belts 2Lⱼ (j=1 to 5), 2Rⱼ (j=1 to 5) that are connected to the pistons 130L, 130R, and the center piston 120 moves forward by being pulled by ends of the belts 2Lⱼ (j=1 to 5), 2Rⱼ (j=1 to 5) that are connected to the piston 120.

When the side pistons 130L, 130R move backward from the first position PF and reach a position PB′ which is slightly before the second position PB, the hammer portion 46LLᵢ of each slide portion 29LLᵢ of the drive mechanisms 10LLᵢ (i=1 to 3) comes into contact with the receiving portion 6LLBᵢ, and the hammer portion 46RRᵢ of each slide portion 29RRᵢ of the drive mechanisms 10RRᵢ (i=1 to 3) comes into contact with the receiving portion 6RRBᵢ. Since this contact, the receiving portions 6LLBᵢ, 6RRBᵢ restrict the slide portions 29LLᵢ, 29RRᵢ from moving backward relative to positions of the receiving portions 6LLBᵢ, 6RRBᵢ. When the side pistons 130L, 130R move further backward, components other than the slide portions 29LLᵢ, 29RRᵢ of each of the drive mechanisms 10LLᵢ (i=1 to 3), 10RRᵢ (i=1 to 3) move backward while leaving the slide portions 29LLᵢ, 29RRᵢ.

When the components other than the slide portions 29LLᵢ of the drive mechanisms 10LLᵢ move backward while leaving the slide portion 29LLᵢ, a position of engagement between the curved plates 44ALLᵢ and 45ALLᵢ and the wheels 36ALLᵢ in the space SPA of the slide portion 29LLᵢ and a position of engagement between the curved plates 44BLLᵢ and 45BLLᵢ and the wheels 36BLLᵢ in the space SPB move to diagonally backward left, and the slide portions 26LLᵢ slide on the guide portions 24LLᵢ to the left. When the components other than the slide portions 29RRᵢ of the drive mechanisms 10RRᵢ move backward while leaving the slide portion 29RRᵢ, a position of engagement between the curved plates 44ARRᵢ and 45ARRᵢ and the wheels 36ARRᵢ in the space SPA of the slide portion 29RRᵢ and a position of engagement between the curved plates 44BRRᵢ and 45BRRᵢ and the wheels 36BRRᵢ in the space SPB move to diagonally backward right, and the slide portions 26RRᵢ slide on the guide portions 24RRᵢ to the right.

When the slide portions 26LLᵢ move to the left, the gears 22ALLᵢ, 22BLLᵢ, 22CLLᵢ, 22DLLᵢ engaging with the linear gears 35ALLᵢ, 35BLLᵢ of the slide portions 26LLᵢ, and the stop plates 1Lₘₖᵢ (m=1 to 4) (k=1 to 4) connected to the linear gears though the support bars 7Lₖᵢ (k=1 to 4) rotate. When the slide portions 26RRᵢ move to the right, the gears 22ARRᵢ, 22BRRᵢ, 22CRRᵢ, 22DRRᵢ engaging with the linear gears 35ARRᵢ, 35BRRᵢ of the slide portions 26RRᵢ, and the stop plates 1Rₘₖᵢ (m=1 to 4) (k=1 to 4) connected to the linear gears though the support bars 7Rₖᵢ (k=1 to 4) rotate. This rotation changes the directions of the stop plates 1Lₘₖᵢ (m=1 to 4) (k=1 to 4), 1Rₘₖᵢ (m=1 to 4) (k=1 to 4) of the flow channels LCH, RCH in the side pistons 130L, 130R, and when the side pistons 130L, 130R reach the first position PF, the directions of the stop plates 1Lₘₖᵢ (m=1 to 4) (k=1 to 4), 1Rₘₖᵢ (m=1 to 4) (k=1 to 4) become orthogonal to the extending directions of the flow channels LCH, RCH.

When the center piston 120 moves forward from the second position PB and reaches a position PF′ which is slightly before the first position PF, the hammer portion 46CLᵢ of each slide portion 29CLᵢ of the drive mechanisms 10CLᵢ (i=1 to 3) comes into contact with the receiving portion 6CLFᵢ, and the hammer portion 46CRᵢ of each slide portion 29CRᵢ of the drive mechanisms 10CRᵢ (i=1 to 3) comes into contact with the receiving portion 6CRFᵢ. Since this contact, the receiving portion 6CLFᵢ, 6CRFᵢ restrict the slide portions 29CLᵢ, 29CRᵢ from moving forward relative to positions of the receiving portions 6CLFᵢ, 6CRFᵢ. When the center piston 120 moves further forward, components other than the slide portions 29CLᵢ, 29CRᵢ of each of the drive mechanisms 10CLᵢ (i=1 to 3), 10CRᵢ (i=1 to 3) move forward while leaving the slide portions 29CLᵢ, 29CRᵢ.

When the components other than the slide portions 29CLᵢ of the drive mechanisms 10CLᵢ move forward while leaving the slide portion 29CLᵢ, a position of engagement between the curved plates 44ACLᵢ and 45ACLᵢ and the wheels 36ACLᵢ in the space SPA of the slide portion 29CLᵢ and a position of engagement between the curved plates 44BCLᵢ and 45BCLᵢ and the wheels 36BCLᵢ in the space SPB move to diagonally forward right, and the slide portions 26CLᵢ slide on the guide portions 24CLᵢ to the right. When the components other than the slide portions 29CRᵢ of the drive mechanisms 10CRᵢ move forward while leaving the slide portion 29CRᵢ, a position of engagement between the curved plates 44ACRᵢ and 45ACRᵢ and the wheels 36ACRᵢ in the space SPA of the slide portion 29CRᵢ and a position of engagement between the curved plates 44BCRᵢ and 45BCRᵢ and the wheels 36BCRᵢ in the space SPB move to diagonally forward left, and the slide portions 26CRᵢ slide on the guide portions 24CRᵢ to the left.

When the slide portions 26CL₁ move to the right, the gears 22ACLᵢ, 22BCLᵢ, 22CCLᵢ, 22DCLᵢ engaging with the linear gears 35ACLᵢ, 35BCLᵢ of the slide portions 26CLᵢ, and the stop plates 1Cₘ₅ᵢ (m=1 to 4), 1Cₘ₆ᵢ (m=1 to 4), 1Cₘ₇ᵢ (m=1 to 4), 1Cₘ₈ᵢ (m=1 to 4) connected to the linear gears though the support bars 7C₅ᵢ, 7C₆ᵢ, 7C₇ᵢ, 7C₈ᵢ rotate. When the slide portions 26CRᵢ move to the left, the gears 22ACRᵢ, 22BCRᵢ, 22CCRᵢ, 22DCRᵢ engaging with the linear gears 35ACRᵢ, 35BCRᵢ of the slide portions 26CRᵢ, and the stop plates 1Cₘ₁ᵢ (m=1 to 4), 1Cₘ₂ᵢ (m=1 to 4), 1Cₘ₃ᵢ (m=1 to 4), 1Cₘ₄ᵢ (m=1 to 4) connected to the linear gears though the support bars 7C₁ᵢ, 7C₂ᵢ, 7C₃ᵢ, 7C₄ᵢ rotate. This rotation changes the directions of the stop plates 1Cₘₙᵢ (m=1 to 4) (n=1 to 8) of the flow channel CCH in the center piston 120, and when the center piston 120 reaches the second position PB, the directions of the stop plates 1Cₘₙᵢ (m=1 to 4) (n=1 to 8) become parallel to the extending direction of the flow channel CCH.

As shown in FIG. 30(A), in the state ST2, the stop plates 1Lₘₖᵢ (m=1 to 4) (k=1 to 4) (i=1 to 3), 1Rₘₖᵢ (m=1 to 4) (k=1 to 4) (i=1 to 3) in the side pistons 130L, 130R are open (directed in a direction parallel to the extending direction of the flow channels LCH, RCH in the side pistons 130L, 130R), and the stop plates 1Cₘₙᵢ (m=1 to 4) (n=1 to 8) (i=1 to 3) in the center piston 120 are closed (directed in a direction orthogonal to the extending directions of the flow channel CCH in the center piston 120). In the state ST2, the magnitude relationship between water flow resistance R_{OUT} of the stop plates 1Lₘₖᵢ (m=1 to 4) (k=1 to 4) (i=1 to 3), 1Rₘₖᵢ (m=1 to 4) (k=1 to 4) (i=1 to 3) in the side pistons 130L, 130R and water flow resistance R_{IN} of the stop plates 1Cₘₙᵢ (m=1 to 4) (n=1 to 8) (i=1 to 3) in the center piston 120 is R_{OUT}<R_{IN}, and the magnitude relationship between a force of flowing water F_{OUT} that pushes the side pistons 130L, 130R backward and a force of flowing water F_{IN} that pushes the center piston 120 backward is F_{OUT}<F_{IN}. Accordingly, in the state ST2, the center piston 120 moves backward while pulling ends of the belts 2Lⱼ (j=1 to 5), 2Rⱼ (j=1 to 5) that are connected to the center piston, and the side pistons 130L, 130R move forward by being pulled by ends of the belts 2Lⱼ (j=1 to 5), 2Rⱼ (j=1 to 5) that are connected to the side pistons.

When the center piston 120 moves backward from the first position PF and reach a position PB′ which is slightly before the second position PB, the hammer portion 46CLᵢ of each slide portion 29CLᵢ of the drive mechanisms 10CLᵢ (i=1 to 3) comes into contact with the receiving portion 6CLBᵢ, and the hammer portion 46CRᵢ of each slide portion 29CRᵢ of the drive mechanisms 10CRᵢ (i=1 to 3) comes into contact with the receiving portion 6CRBᵢ. Since this contact, the receiving portions 6CLBᵢ, 6CRBᵢ restrict the slide portions 29CLᵢ, 29CRᵢ from moving backward relative to positions of the receiving portions 6CLBᵢ, 6CRBᵢ. When the center piston 120 moves further backward, components other than the slide portions 29CLᵢ, 29CRᵢ of each of the drive mechanisms 10CLᵢ (i=1 to 3), 10CRᵢ (i=1 to 3) move backward while leaving the slide portions 29CLᵢ, 29CRᵢ.

When the components other than the slide portions 29CLᵢ of the drive mechanisms 10CLᵢ move backward while leaving the slide portion 29CLᵢ, a position of engagement between the curved plates 44ACLᵢ and 45ACLᵢ and the wheels 36ACLᵢ in the space SPA of the slide portion 29CLᵢ and a position of engagement between the curved plates 44BCLᵢ and 45BCLᵢ and the wheels 36BCLᵢ in the space SPB move to diagonally backward left, and the slide portions 26CLᵢ slide on the guide portions 24CLᵢ to the left. When the components other than the slide portions 29CRᵢ of the drive mechanisms 10CRᵢ move backward while leaving the slide portion 29CRᵢ, a position of engagement between the curved plates 44ACRᵢ and 45ACRᵢ and the wheels 36ACRᵢ in the space SPA of the slide portion 29CRᵢ and a position of engagement between the curved plates 44BCRᵢ and 45BCRᵢ and the wheels 36BCRᵢ in the space SPB move to diagonally backward right, and the slide portions 26CRᵢ slide on the guide portions 24CRᵢ to the right.

When the slide portions 26CLᵢ move to the left, the gears 22ACLᵢ, 22BCLᵢ, 22CCLᵢ, 22DCLᵢ engaging with the linear gears 35ACLᵢ, 35BCLᵢ of the slide portions 26CLᵢ, and the stop plates 1Cₘ₅ᵢ (m=1 to 4), 1Cₘ₆ᵢ (m=1 to 4), 1Cₘ₇ᵢ (m=1 to 4), 1Cₘ₈ᵢ (m=1 to 4) connected to the linear gears though the support bars 7C₅ᵢ, 7C₆ᵢ, 7C₇ᵢ, 7C₈ᵢ rotate. When the slide portions 26CRᵢ move to the right, the gears 22ACRᵢ, 22BCRᵢ, 22CCRᵢ, 22DCRᵢ engaging with the linear gears 35ACRᵢ, 35BCRᵢ of the slide portions 26CRᵢ, and the stop plates 1Cₘ₁ᵢ (m=1 to 4), 1Cₘ₂ᵢ (m=1 to 4), 1Cₘ₃ᵢ (m=1 to 4), 1Cₘ₄ᵢ (m=1 to 4) connected to the linear gears though the support bars 7C₁ᵢ, 7C₂ᵢ, 7C₃ᵢ, 7C₄ᵢ rotate. This rotation changes the directions of the stop plates 1Cₘₙᵢ (m=1 to 4) (n=1 to 8) of the flow channel CCH in the center piston 120, and when the center piston 120 reaches the second position PB, the directions of the stop plates 1Cₘₙᵢ (m=1 to 4) (n=1 to 8) become parallel to the extending direction of the flow channel CCH.

When the side pistons 130L, 130R move forward from the second position PB and reaches a position PF′ which is slightly before the first position PF, the hammer portion 46LLᵢ of each slide portion 29LLᵢ of the drive mechanisms 10LLᵢ (i=1 to 3) comes into contact with the receiving portion 6LLFᵢ, and the hammer portion 46RRᵢ of each slide portion 29RRᵢ of the drive mechanisms 10RRᵢ (i=1 to 3) comes into contact with the receiving portion 6RRFᵢ. Since this contact, the receiving portions 6LLFᵢ, 6RRFᵢ restrict the slide portions 29LLᵢ, 29RRᵢ from moving forward relative to positions of the receiving portions 6LLFᵢ, 6RRFᵢ. When the side pistons 130L, 130R move further forward, components other than the slide portions 29LLᵢ, 29RRᵢ of each of the drive mechanisms 10LLᵢ (i=1 to 3), 10RRᵢ (i=1 to 3) move forward while leaving the slide portions 29LLᵢ, 29RRᵢ.

When the components other than the slide portions 29LLᵢ of the drive mechanisms 10LLᵢ move forward while leaving the slide portion 29LLᵢ, a position of engagement between the curved plates 44ALLᵢ and 45ALLᵢ and the wheels 36ALLᵢ in the space SPA of the slide portion 29LLᵢ and a position of engagement between the curved plates 44BLLᵢ and 45BLLᵢ and the wheels 36BLLᵢ in the space SPB move to diagonally forward right, and the slide portions 26LLᵢ slide on the guide portions 24LLᵢ to the right. When the components other than the slide portions 29RRᵢ of the drive mechanisms 10RRᵢ move forward while leaving the slide portion 29RRᵢ, a position of engagement between the curved plates 44ARRᵢ and 45ARRᵢ and the wheels 36ARRᵢ in the space SPA of the slide portion 29CRᵢ and a position of engagement between the curved plates 44BRRᵢ and 45BRRᵢ and the wheels 36BRRᵢ in the space SPB move to diagonally forward left, and the slide portions 26RRᵢ slide on the guide portions 24RRᵢ to the left.

When the slide portions 26LLᵢ move to the right, the gears 22ALLᵢ, 22BLLᵢ, 22CLLᵢ, 22DLLᵢ engaging with the linear gears 35ALLᵢ, 35BLLᵢ of the slide portions 26LLᵢ, and the stop plates 1Lₘₖᵢ (m=1 to 4) (k=1 to 4) connected to the linear gears though the support bars 7Lₖᵢ (k=1 to 4) rotate. When the slide portions 26RRᵢ move to the left, the gears 22ARRᵢ, 22BRRᵢ, 22CRRᵢ, 22DRRᵢ engaging with the linear gears 35ARRᵢ, 35BRRᵢ of the slide portions 26RRᵢ, and the stop plates 1Rₘₖᵢ (m=1 to 4) (k=1 to 4) connected to the linear gears though the support bars 7Rₖᵢ (k=1 to 4) rotate. This rotation changes the directions of the stop plates 1Lₘₖᵢ (m=1 to 4) (k=1 to 4), 1Rₘₖᵢ (m=1 to 4) (k=1 to 4) of the flow channels LCH, RCH in the side pistons 130L, 130R, and when the side pistons 130L, 130R reach the first position PF, the directions of the stop plates 1Lₘₖᵢ (m=1 to 4) (k=1 to 4), 1Rₘₖᵢ (m=1 to 4) (k=1 to 4) become orthogonal to the extending directions of the flow channels LCH, RCH.

The details of the configuration of the present embodiment was described above. According to the present embodiment, the following advantages are obtained.

First, in the present embodiment, the center piston 120 and the side pistons 130L, 130R are supported so as to be movable alternately forward and backward in opposite directions. In addition, water flow resistance R_{IN} (or R_{OUT}) of a stop plate for one of the center piston 120 or the side pistons 130L, 130R which moves backward becomes smaller, and water flow resistance R_{IN} (or R_{OUT}) of a stop plate for one of the center piston 120 or the side pistons 130L, 130R which moves forward becomes larger. In addition, a forward driving force of the center piston 120 among the center piston 120 and the side pistons 130L, 130R which is connected to the rotating disk 102 through the crank ship 140 is converted to the rotational force of the rotating disk 102 by the crank ship 140. Therefore, according to the present embodiment, power generation whose power source is the reciprocating motion of the center piston 120 and the side pistons 130L, 130R continues as long as flowing water exists. Thus, according to the present embodiment, unlike the conventional method in which a propeller or a turbine is installed, kinetic energy existing over a long distance in a flowing water direction can be directly transmitted to the rotating disk, so that energy of the flowing water which flows through a marine area can be efficiently converted to electric power.

Secondly, in the present embodiment, stop plates are supported so as to be rotatable about a support bar as a rotation axis which is an axis in a direction orthogonal to the extending direction of a flow channel. Then, the drive mechanism of each of the two types of pistons turns a stop plate of the relevant piston to direct the stop plate in a direction orthogonal to the extending direction of the flow channel in the piston when the piston reaches the first position PF, and turns the stop plate of the relevant piston to direct the stop plate in a direction parallel to the extending direction of the flow channel in the piston when the piston reaches the second position PB posterior to the first position PF. Therefore, according to the present embodiment, when the piston reaches the first position PF, water flow resistance R_{IN} (or R_{OUT}) of the stop plate of the piston becomes maximum, and when the piston reaches the second position PB, water flow resistance R_{IN} (or R_{OUT}) of the stop plate of the piston becomes minimum. Therefore, according to the present embodiment, the power generation efficiency can be further increased.

Thirdly, in the present embodiment, the volume of the flow channel CCH of the center piston 120 equals to the total volume of the flow channels LCH, RCH of the side pistons 130L, 130R. Further, the cross sectional area of a cross section of the flow channel CCH of the center piston 120, the cross section of which is orthogonal to an extending direction of the flow channel CCH equals to the total cross sectional area of cross sections of the flow channels LCH, RCH of the side pistons 130L, 130R, the cross sections of which are orthogonal to extending directions of the flow channels LCH, RCH. As a result, in the present embodiment, the speed of movement from the first position PF to the second position PB and the speed of movement from the second position PB to the first position PF of the center piston 120 and the side pistons 130L, 130R are approximately the same. Therefore, according to the present embodiment, the variation in rotational speed of the rotating disk 102 of the power generation tower 100 becomes smaller. Thus, according to the present embodiment, the amount of power generation of the power generator 104 can be stabilized.

Although one embodiment of the present invention has been described above, such an embodiment can be modified as described below.

(1) In the above embodiment, the number of stop plates 1Cₘₙᵢ in the center piston 120 may be more or less than 32. Further, the number of the stop plates 1Lₘₖ₁, 1Rₘₖ₁ in the side pistons 130L, 130R may be more or less than 16.

(2) In the above embodiment, the stop plates 1Cₘₙᵢ, 1Lₘₖᵢ, 1Rₘₖᵢ are supported by the support bars 7Cₙᵢ, 7Lₖᵢ, 7Rₖᵢ which extend through the stop plates in height H1 direction, and directions of the stop plates 1Cₘₙᵢ, 1Lₘₖᵢ, 1Rₘₖᵢ are changed by rotating the support bars 7Cₙᵢ, 7Lₖᵢ, 7Rₖᵢ. However, the stop plates 1Cₘₙᵢ, 1Lₘₖᵢ, 1Rₘₖᵢ may be supported by support bars which extend through the stop plates in width W1 direction. In this case, it may be preferable that wheels are pivotally mounted to the left end or the right end of each support bar, belts are wound around these wheels, and piston movement between the first position PF and the second position PB is operatively connected to driving of the belts, thereby changing the direction of the stop plates 1Cₘₙᵢ, 1Lₘₖᵢ, 1Rₘₖᵢ.

(3) In the above embodiment, a plurality of pistons may be connected in the forward and backward direction with respect to each of the center piston 120 and the side pistons 130L, 130R. The amount of power generation of the water flow generator 90 in the above embodiment is dependent on the volume of the flow channels CCH, LCH, RCH. Therefore, for example, if two sets of the center piston 120 and the side pistons 130L, 130R are connected in the forward and backward direction, the amount of power generation is doubled, and if three sets of them are connected, the amount of power generation is tripled. Therefore, according to this modification, a greater amount of power generation can be obtained.

(4) In the above embodiment, by the drive mechanisms 10CLᵢ (i=1 to 3), 10CRᵢ (i=1 to 3), 10CLᵢ (i=1 to 3), and 10CRᵢ (i=1 to 3), a stop plate of one of the center piston 120 or the side pistons 130L, 130R which reaches the first position PF is directed in a direction orthogonal to the extending direction of the flow channel, and a stop plate of one of the center piston 120 or the side pistons 130L, 130R which reaches the second position PB is directed in a direction parallel to the extending direction of the flow channel. However, a stop plate of a piston which reaches the first position PF may be directed in a direction diagonal to the extending direction of the flow channel, and a stop plate of a piston which reaches the second position PB may be directed in a direction parallel to the extending direction of the flow channel. Alternatively, a stop plate of a piston which reaches the first position PF may be directed in a direction orthogonal to the extending direction of the flow channel, and a stop plate of a piston which reaches the second position PB may be directed in a direction diagonal to the extending direction of the flow channel.

(5) In the above embodiment, the front face and the rear face of the cylinder portion of the slide portions 29CLᵢ, 29CRᵢ, 29LLᵢ, 29RRᵢ, have a hole formed thereon, and on the side of the cylinder portion, there is the recessed portion Z in a position slightly posterior to the front face and a position slightly anterior to the rear face. However, they may be shaped without the cylinder portion and the recessed portion Z.

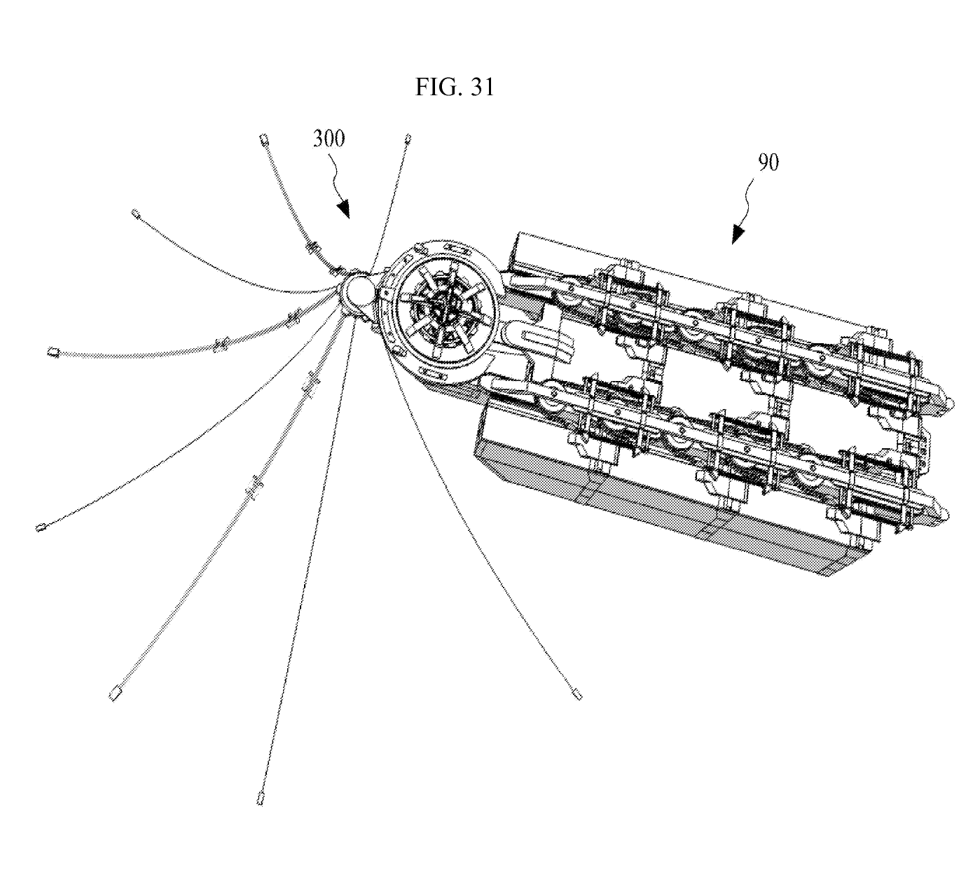

(6) In the above embodiment, any equipment may be used to moor the water flow generator 90. Desirably, as shown in FIG. 31, for example, an FPSO (Floating Production, Storage and Offloading system) 300 may be used to moor the water flow generator 90.

(7) In the above embodiment, at the time of adverse weather such as typhoon, the center piston 120 or the side pistons 130L, 130R may be fixed to the floating bodies 111L and 111R may be fixed to stop movement of the pistons 120, 130L, 130R. For example, a first fixing part which engages with the pistons 120, 130L is provided on each side of the pistons 120, 130L on the floating body 111L, and a second fixing part which engages with the pistons 120, 130R is provided on each side of the pistons 120, 130R on the floating body 111R, so that switching between engagement of the two fixing parts with the positions 120, 130L, 130R and its release may be performed depending on the weather.

(8) In the above embodiment, the water flow generator 90 includes the two floating bodies 111L and 111R which forms the twin float 110. However, the number of the floating bodies 111 may be one, or more than two floating bodies 111 may be arranged at intervals in the right-left direction. In a case where the number of floating bodies of the water flow generator 90 is one, it may be preferable that two pistons are provided on both right and left sides, one power generation tower is provided on each head of the two pistons, and power generators of the two power generation towers are caused to generate power by driving forces of the respective pistons. In a case where the number of floating bodies of the water flow generator 90 is three, it may be preferable that a total of four pistons are provided one by one between a middle floating body 111C and a left-side floating body 111L, between the middle floating body 111C and a right-side floating body 111R, on the left side of the left-side floating body 111L, and on the right side of the right-side floating body 111R, and one power generation tower is provided on each head of the four pistons, and power generators of the four power generation towers are caused to generate power by driving forces of the respective pistons.

(9) In the above embodiment, the water flow generator 90 includes the power generation tower 100, and the rotating disk 102 of the tower generation tower 100 is rotated by forward movement of the pistons 120, 130, and the power generator 104 in the power generation tower 120 generates power by the rotational force of the rotating disk 102. However, the power generator 104 may be connected to the pulleys 3L, 3R by a link mechanism, and the power generator 104 may generate power by the rotational force of the pulleys 3L, 3R. In this case, the power generator 104 may be installed on the floating bodies 111L, 111R or the pistons 120, 130 without providing the power generation tower 100 in the water flow generator 90. In other words, the power generator 104 may be configured to generate electric power by the rotational force of the rotating disk 102 or the rotational force of the pulleys 3L, 3R which is rotated by the forward movement or backward movement of the positions 120, 130.

What is claimed is:

1-4. (canceled)

5. A water flow generator comprising:
a power generation tower which includes a power generator, a rotating disk that rotates about an axis, and a gear mechanism that transmits rotational force of the rotating disk to the power generator;
a twin float which includes two floating bodies spaced apart, and one or more pulleys, each of the two floating bodies extends in a forward and backward direction and supports the power generation tower by a forward end of the floating body, the one or more pulleys pivotally mounted on one surface of each of the two floating bodies;
a belt wound around each of the one or more pulleys;
two types of pistons respectively supported by one end and another end of the belts so as to be movable alternately forward and backward in opposite directions with respect to one another within an inside movement space that is a space between the two floating bodies and outside movement spaces between which and the inside movement space the two floating bodies are sandwiched, each of the pistons including a plurality of walls that surrounds a flow channel extending in the forward and backward direction, one or more stop plates supported within the flow channel, and a drive mechanism that moves the one or more stop plates so as to decrease water flow resistance of the one or more stop plates in the piston when the piston moves backward, and to increase water flow resistance of the one or more stop plates in the piston when the piston moves forward; and
a crank ship that connects one of the plurality of pistons to the rotating disk in a position away from the rotation axis of the rotating disk.

6. The water flow generator according to claim 5, wherein
each of the one or more stop plates are supported so as to be rotatable about an axis in a direction orthogonal to an extending direction of the flow channel,
the drive mechanism of each of the pistons turns the one or more stop plates of the relevant piston to be orthogonal to the extending direction of the flow channel in the piston when the piston reaches a first position, and turns the one or more stop plates of the relevant piston to be parallel to the extending direction of the flow channel in the piston when the piston reaches a second position posterior to the first position.

7. The water flow generator according to claim 6, wherein a total volume of the flow channel of one type of piston, which is placed in the inside movement space, of the two types of pistons equals to a total volume of the flow channels of another type of pistons, which are placed in the outside movement spaces, of the two types of pistons, and a total cross sectional area of cross section of the flow channel of the one type of piston equals to a total cross sectional area of cross sections of the other type of pistons, the cross sections being orthogonal to extending directions of the respective flow channels.
